(19) United States
(12) Patent Application Publication
(10) Pub. No.: US 2024/0339243 A1
(43) Pub. Date: Oct. 10, 2024

(54) WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Taiji MOCHIZUKI, Osaka (JP); Yoshiaki YAMANO, Osaka (JP); Shigeto KATO, Osaka (JP); Tomoaki TAKANO, Osaka (JP)

(21) Appl. No.: 18/579,429

(22) PCT Filed: Jun. 10, 2022
(86) PCT No.: PCT/JP2022/023542

§ 371 Date: Jan. 15, 2024

(30) Foreign Application Priority Data
Jul. 19, 2021 (JP) 2021-119179

(51) Int. Cl. H01B 7/00; B60R 16/02; H01B 7/08; H01B 7/22; H01B 7/29

(52) U.S. Cl. CPC H01B 7/0045; H01B 7/0823; H01B 7/0869; H01B 7/221; H01B 7/292; B60R 16/0215

(57) ABSTRACT

A wire harness (30) includes a wire bundle (40) having a plurality of electrical wires (41). The wire bundle (40) has a flat part (45) in which the plurality of wires (41) are lined up flat in at least part thereof in an extension direction (X) of the wire bundle (40). The wire harness (30) includes a first tape member (50) and a second tape member (60) that are affixed together with the flat part (45) sandwiched therebetween from both sides in a thickness direction of the flat part (45).

### TECHNICAL FIELD

The present disclosure relates to a wire harness.

### BACKGROUND

Conventionally, with wire harnesses that are installed in vehicles such as cars, parts of the wire harness may be disposed in narrow locations such as between peripheral members. Thus, some of these wire harnesses include a flat part having a flat shape that is flat and thin. These wire harnesses are routed in vehicles such that the flat part is disposed in a narrow location.

Some wire harnesses that have a flat part are provided with a wire flattening member for maintaining a plurality of electrical wires in a flat state, such as described in Patent Document 1, for example. The wire flattening member is, for example, a resin molded article. The wire flattening member is fixed to the plurality of wires by a bundling material such as adhesive tape after being disposed with respect to the wires.

### PRIOR ART DOCUMENT

### Patent Document

Patent Document 1: JP 2013-030344 A

### SUMMARY OF THE INVENTION

### Problems to be Solved

However, in the case of using a wire flattening member in order to maintain a plurality of wires in a flat state, the shape of the wire flattening member that is manufactured will depend on the diameter of the wires and number of wires. Also, in the case of maintaining a plurality of wires in a flat state using a wire flattening member, a process of disposing the wire flattening member with respect to the plurality of wires and a process of fixing the wire flattening member to the wires with a bundling material are performed. Thus, it is desired to be able to easily maintain a plurality of wires in a flat state in a flat part.

An object of the present disclosure is to provide a wire harness that is able to easily maintain a plurality of wires in a flat state in a flat part.

### Means to Solve the Problem

The wire harness of the present disclosure is a wire harness including a wire bundle having a plurality of electrical wires and a flat part in which the plurality of wires are lined up flat in at least part thereof in a direction in which the wire bundle extends, and a first tape member and a second tape member affixed together with the flat part sandwiched therebetween from both sides in a thickness direction of the flat part.

### Effect of the Invention

According to the wire harness of the present disclosure, the shape of wires in a flat part can be easily maintained.

### BRIEF DESCRIPTION OF THE DRAWINGS

FIG. 1 is a perspective view showing part of a wire harness in a first embodiment.

FIG. 2 is a transverse sectional view of the wire harness in the first embodiment.

FIG. 3 is a perspective view showing part of a wire harness in a second embodiment.

FIG. 4 is a transverse sectional view of the wire harness in the second embodiment.

FIG. 5 is a perspective view showing part of a wire harness in a third embodiment.

FIG. 6 is a transverse sectional view of the wire harness in the third embodiment.

FIG. 7 is a front view showing part of a wire harness in a fourth embodiment.

FIG. 8 is a transverse sectional view of the wire harness in the fourth embodiment.

FIG. 9 is a transverse sectional view of the wire harness in the fourth embodiment.

FIG. 10 is a front view showing part of a wire harness in a fifth embodiment.

FIG. 11 is a transverse sectional view of the wire harness in the fifth embodiment.

FIG. 12 is a front view showing part of a wire harness in a sixth embodiment.

FIG. 13 is a transverse sectional view of the wire harness in the sixth embodiment.

FIG. 14 is a perspective view showing part of a wire harness in a seventh embodiment.

FIG. 15 is a longitudinal sectional view showing part of the wire harness in the seventh embodiment.

FIG. 16 is a longitudinal sectional view showing part of a wire harness in an eighth embodiment.

FIG. 17 is a transverse sectional view of the wire harness in the eighth embodiment.

FIG. 18 is a perspective view showing part of a wire harness in a ninth embodiment.

FIG. 19 is a transverse sectional view of the wire harness in the ninth embodiment.

FIG. 20 is a perspective view showing part of a wire harness in a tenth embodiment.

FIG. 21 is a longitudinal sectional view showing part of the wire harness in the tenth embodiment.

FIG. 22 is a perspective view showing part of a wire harness in an eleventh embodiment.

FIG. 23 is a longitudinal sectional view showing part of the wire harness in the eleventh embodiment.

FIG. 24 is a transverse sectional view of the wire harness in the eleventh embodiment.

FIG. 25 is a front view showing part of a wire harness in a modification.

FIG. 26 is a side view showing part of the wire harness in a modification.

FIG. 27 is a sectional view of the wire harness in the modification shown in FIG. 26.

FIG. 28 is a transverse sectional view of a wire harness in a modification.

FIG. 29 is a transverse sectional view of a wire harness in a modification.

FIG. 30 is a transverse sectional view of a wire harness in a modification.

FIG. 31 is a transverse sectional view of a wire harness in a modification.

### DETAILED DESCRIPTION TO EXECUTE THE INVENTION

### [Description of Embodiments of Disclosure]

Initially, modes of the present disclosure will be enumerated and described.

A wire harness of the present disclosure is:

[1] A wire harness including a wire bundle having a plurality of electrical wires and a flat part in which the plurality of wires are lined up flat in at least part thereof in a direction in which the wire bundle extends, and a first tape member and a second tape member affixed together with the flat part sandwiched therebetween from both sides in a thickness direction of the flat part.

According to this configuration, by affixing the first tape member and the second tape member together, the flat part sandwiched between the first tape member and the second tape member can be maintained in a state where the plurality of wires are lined up flat. Accordingly, the plurality of wires in the flat part can be easily maintained in a flat state by the first tape member and the second tape member.

[2] In [1] above, the first tape member and the second tape member may each be band shaped and extend in the direction in which the wire bundle extends. According to this configuration, the plurality of wires in the flat part can be easily maintained in a flat state over the range in which the first tape member and the second tape member are affixed together in the direction in which the wire bundle extends.

[3] In [1] or [2] above, the first tape member and the second tape member may be directly affixed to each other on both sides in a width direction of the flat part. According to this configuration, movement of the second tape member relative to the first tape member is suppressed. Accordingly, due to the first tape member and the second tape member, the plurality of wires in the flat part are more easily maintained in a flat state. Also, the outer periphery of the flat part can be surrounded around its entirety by the first tape member and the second tape member. Accordingly, peripheral members or the like coming in direct contact with the flat part when the wire harness is routed can be suppressed by the first tape member and the second tape member. In other words, the wire harness can be protected.

[4] In any of [1] to [3] above, at least one of the first tape member and the second tape member may be adhered to at least part of an outer peripheral surface of at least one of the wires located between the first tape member and the second tape member. According to this configuration, the plurality of wires in the flat part are even more easily maintained in a flat state.

[5] In any of [1] to [4] above, at least one of the first tape member and the second tape member may have a circular-arc sticking portion that is circular arc shaped around an outer peripheral surface of at least one of the wires located between the first tape member and the second tape member and adhered to the outer peripheral surface. According to this configuration, the plurality of wires in the flat part are still even more easily maintained in a state of being lined up flat.

[6] In any of [1] to [5] above, the first tape member and the second tape member may be directly affixed to each other between the wires adjacent in the flat part. According to this configuration, in the flat part, the plurality of wires are maintained in the state of being spaced apart from each other in the width direction of the flat part by the first tape member and the second tape member. Thus, the surface area of the portion in which the first tape member and the second tape member cover the wires can be increased, compared with the case where wires adjacent in the width direction of the flat part are in contact with each other. Accordingly, heat dissipation in the flat part can be improved.

[7] In any of [1] to [6] above, the first tape member and the second tape member may each have a plurality of pieces of tape overlaid on each other in the thickness direction of the flat part. According to this configuration, by adjusting the number of pieces of tape, the respective thicknesses of the first tape member and the second tape member in the thickness direction of the flat part can be adjusted. Also, the first tape member and the second tape member can each be constituted by a plurality of types of tape.

[8] In any of [1] to [7] above, at least one of the first tape member and the second tape member may include at least one of wire bundling tape for use in bundling wires and having a band-shaped substrate and an adhesive layer laminated on one surface of the substrate thereof, protective tape having a substrate greater in thickness than the substrate included in the wire bundling tape and an adhesive layer laminated on one surface of the substrate thereof, sound absorbing tape having a band-shaped porous substrate, heat-resistant tape having superior heat resistance to the wire bundling tape, metal tape having a band-shaped metal substrate, double-sided tape having a band-shaped substrate and an adhesive layer laminated on both surfaces of the substrate thereof, a band-shaped hook-and-loop fastener, and magnetic tape having a substrate that is a band-shaped magnet.

According to this configuration, since wire bundling tape is readily available, when at least one of the first tape member and the second tape member include wire bundling tape, the at least one of the first tape member and second tape member is easily prepared. When at least one of the first tape member and the second tape member includes protective tape, the portion of the flat part that is covered with the protective tape can be protected from peripheral members by the protective tape. When at least one of the first tape member and the second tape member includes sound absorbing tape, occurrence of abnormal noise can be suppressed, in the case where the portion of the flat part to which the sound absorbing tape is adhered knocks or rubs against peripheral members. When at least one of the first tape member and the second tape member includes heat-resistant tape, the heat resistance of the flat part can be improved.

When at least one of the first tape member and the second tape member includes metal tape, electromagnetic noise being emitted externally from the wires in the flat part can be suppressed by the metal tape, in the portion of the flat part to which the metal tape is adhered. Also, in this same portion, ingress of external electromagnetic noise into the wires in the flat part can be suppressed by the metal tape. Also, in this same portion, since the metal tape is able to reflect radiant heat, an increase in temperature of the wires in the flat part can be suppressed.

When at least one of the first tape member and the second tape member includes double-sided tape, one of the two adhesive layers of the double-sided tape can be adhered to the flat part. Furthermore, the flat part can be easily fixed, by adhering the other adhesive layer to the routing location of the flat part. In other words, a component for fixing the flat part need not be separately prepared. When at least one of the first tape member and the second tape member includes a hook-and-loop fastener, the flat part can be easily fixed to the routing location of the flat part utilizing the hook-and-loop fastener, in the case where the routing location has a surface to which the hook-and-loop fastener is attachable. When at least one of the first tape member and the second tape member includes magnetic tape, the flat part can be easily fixed by magnetic force utilizing the magnetic tape, in the case where the routing location of the flat part has a portion made of a material that is attracted to a magnet.

[9] In [8] above, the wire bundling tape may be polyvinyl chloride tape. According to this configuration, the wire bundling tape that is used as a material of at least one of the first tape member and the second tape member can be more readily obtained.

[10] In [8] above, the protective tape may be polypropylene tape. According to this configuration, the protective tape that is used as a material of at least one of the first tape member and the second tape member can be readily obtained.

[11] In [7] above, the plurality of pieces of tape of at least one of the first tape member and the second tape member may be pieces of tape of the same type overlaid on each other in the thickness direction of the flat part. According to this configuration, the thickness of at least one of the first tape member and the second tape member in the thickness direction of the flat part can be more easily increased by layering the same type of tape. In addition, the portion of the flat part that is covered by the portion in which the plurality of pieces of tape of the same type are overlaid on each other can be protected from peripheral members by the portion in which the plurality of pieces of tape of the same type are overlaid on each other. Also, a plurality of pieces of tape can be easily prepared, compared with the case where different types of tape are overlaid on each other.

[12] In any of [1] to [11] above, the first tape member and the second tape member may each have at least one piece of tape, the tape of one of the first tape member and the second tape member may have a first width and the tape of the other of the first tape member and the second tape member may have a second width greater than the first width, and the tape having the first width and the tape having the second width may be overlaid on the flat part from both sides in the thickness direction of the flat part. According to this configuration, the tape having the second width protrudes further in the width direction of the flat part than the tape having the first width. The flat part can thus be easily fixed, due to the portion of the tape having the second width that protrudes further in the width direction of the flat part than the tape having the first width being adhered to the routing location of the flat part. In other words, a component for fixing the flat part need not be separately prepared.

[13] In any of [7], [11] and [12] above, the plurality of pieces of tape of at least one of the first tape member and the second tape member may include tape having a first length and tape having a second length longer than the first length, and the tape having the first length and the tape having the second length may have a portion in which the pieces of tape are overlaid on each other in the thickness direction of the flat part.

According to this configuration, in at least one of the first tape member and the second tape member, the portion in which the tape having the first length and the tape having the second length are overlaid on each other is thicker in the thickness direction of the flat part than the portion in which the two pieces of tape are not overlaid on each other. Accordingly, due to the portion in which the tape having the first length and the tape having the second length overlap each other being disposed in a portion of at least one of the first tape member and the second tape member where it is desired to increase the thickness in the thickness direction of the flat part, the thickness can be easily partially increased. For example, due to the portion in which the tape having the first length and the tape having the second length overlap each other being disposed on a portion of the flat part where it is desired to strengthen protection, protection of this portion from peripheral members can be easily strengthened. Also, the at least one of the first tape member and the second tape member can be partially provided, in the length direction of the wire bundle, with the function of the tape having the first length. Furthermore, the at least one of the first tape member and the second tape member can be fully or partially provided, in the length direction of the wire bundle, with the function of the tape having the second length.

[14] In any of [7], [11], [12] and [13] above, the plurality of pieces of tape included in the first tape member may be paired one-to-one with the plurality of pieces of tape included in the second tape member, the paired pieces of tape may be overlaid on each other with the flat part sandwiched therebetween from both sides in the thickness direction of the flat part and positions thereof in the direction in which the wire bundle extends may be the same as each other, the pieces of tape forming at least one of the plurality of pairs of tape may differ from each other in width, the plurality of pieces of tape included in the first tape member may each at least partially overlap at least one of the plurality of pieces of tape included in the first tape member in the thickness direction of the flat part, and the plurality of pieces of tape included in the second tape member may each at least partially overlap at least one of the plurality of pieces of tape included in the second tape member in the thickness direction of the flat part.

According to this configuration, when paired pieces of tape having different widths to each other are overlaid on each other, the wider tape protrudes further in the width direction of the flat part than the narrower tape. The flat part can thus be easily fixed, due to the portion of the wider tape that protrudes in the width direction of the flat part further than the narrower tape being adhered to the routing location of the flat part. In other words, a component for fixing the flat part need not be separately prepared.

Also, in each of the first tape member and the second tape member, the plurality of pieces of tape need only each be disposed so as to overlap a different piece of tape in the thickness direction of the flat part. Thus, the plurality of pieces of tape can each be easily disposed in a desired position in the length direction of the wire bundle, according to the functions of the respective pieces of tape. Also, due to the portion in which the plurality of pieces of tape overlap each other being disposed so as to overlap a portion of the flat part where it is desired to strengthen protection, protection from peripheral members can be easily strengthened.

[15] In any of [1] to [14] above, the wire bundle may have two of the flat part spaced apart from each other in the direction in which the wire bundle extends, and a stacked part located between the two flat parts in the direction in which the wire bundle extends and in which the wires are arranged differently to the wires in the flat parts, the two flat parts and the stacked part may be sandwiched between the first tape member and the second tape member, and the plurality of wires in the stacked part may be arranged such that the stacked part is greater in thickness than the flat parts in the thickness direction of the flat parts and is narrower in width than the flat parts in a width direction of the flat parts.

According to this configuration, the plurality of wires in the stacked part have fewer portions in contact with the first tape member and the second tape member, compared with the plurality of wires in the flat part. Thus, the stacked part is easily bent compared with the flat part. Accordingly, the stacked part located between the two flat parts can be easily bent to route the wire harness. In other words, the wire harness can be provided with flexibility.

[16] In any of [1] to [14] above, the flat part may have a flat bent portion in which the plurality of wires bend as seen in the thickness direction of the flat part, the plurality of wires in the flat bent portion may be lined up in a row in a width direction of the flat part, and bend while maintaining the arrangement of being lined up in a row as seen in the thickness direction of the flat part, and the first tape member and the second tape member may sandwich the flat bent portion from both sides in the thickness direction of the flat part, and maintain the arrangement and bent shape of the plurality of wires in the flat bent portion.

According to this configuration, the portion of the wire bundle in which the plurality of wires bend can also be maintained in a flat state by the first tape member and the second tape member. Accordingly, even in the case where the routing location of the flat part is narrow and bends, the flat part can be disposed in the routing location.

[17] In any of [1] to [14] above, the wire bundle may have a single-layer bent part in which the plurality of wires bend while lined up flat at a position shifted from the flat part in the direction in which the wire bundle extends, the plurality of wires in the single-layer bent part may be lined up in a row in a direction orthogonal to a thickness direction of the single-layer bent part, and bend while maintaining the arrangement of being lined up in a row, as seen in the thickness direction of the single-layer bend portion, the wire harness may further include a third tape member and a fourth tape member affixed together with the single-layer bent part sandwiched therebetween from both sides in the thickness direction of the single-layer bent part, and the third tape member and the fourth tape member may maintain the arrangement and bent shape of the plurality of wires in the single-layer bent part.

According to this configuration, the single-layer bent part in which the plurality of wires bend at a position spaced apart from the flat part in the wire bundle can also be easily maintained in a flat state by the third tape member and the fourth tape member. Accordingly, the wire harness can be easily disposed in narrow locations with the wire bundle in a bent state.

[18] In any of [1] to [14] above, the wire bundle may have a stacked bent part in which the wire bundle bends at a position shifted from the flat part in the direction in which the wire bundle extends, the plurality of wires in the stacked bent part may bend in a state where the stacked bent part is greater in thickness than the flat part in the thickness direction of the flat part and is narrower in width than the flat part in a width direction of the flat part, the wire harness may further include a first bend fixing tape member and a second bend fixing tape member affixed together with the stacked bent part sandwiched therebetween, and the first bend fixing tape member and the second bend fixing tape member may maintain the arrangement and bent shape of the plurality of wires in the stacked bent part.

According to this configuration, in the case where the routing location of the wire harness has a bent part, the stacked bent part can be formed into a shape that corresponds to the shape of the bent part. Furthermore, the stacked bent part can be maintained in a bent shape by the first bend fixing tape member and the second bend fixing tape member. Accordingly, routing of the wire harness having a flat part can be performed more easily.

[19] In any of [1] to [18] above, the flat part may be maintained in a straight state by the first tape member and the second tape member, as seen in a width direction of the flat part. According to this configuration, the flat part can be easily routed, in the case where the routing location of the flat part is straight.

[20] In any of [1] to [18] above, the flat part may be maintained in a curved shape by the first tape member and the second tape member, as seen in a width direction of the flat part. According to this configuration, the flat part can be easily routed, in the case where the routing location of the flat part is curved.

### DETAILED DESCRIPTION OF EMBODIMENTS OF DISCLOSURE

Specific examples of a wire harness of the present disclosure will now be described below with reference to the drawings. Note that the present disclosure is not limited to these illustrative examples and is indicated by the patent claims, and all changes that come within the meaning and range of equivalency of the patent claims are intended to be embraced therein. Also, the appended drawings may show constituent elements in an enlarged manner in order to facilitate understanding. In the appended drawings, the dimensional ratios of constituent elements may differ from actual size and between diagrams.

### First Embodiment

Hereinafter, a first embodiment of a wire harness will be described.

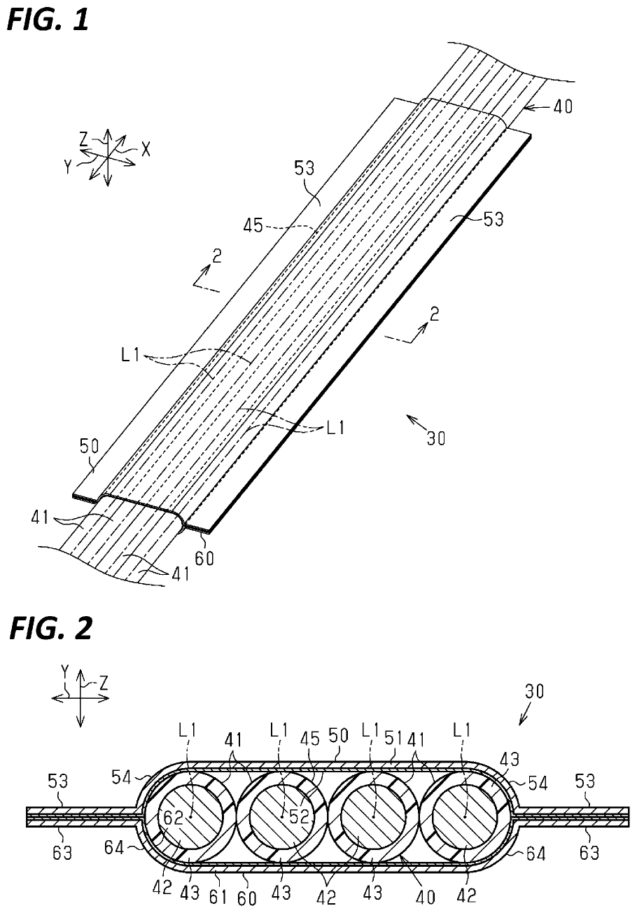

A wire harness 30 shown in FIG. 1 is installed in a vehicle such as a car, for example.

The wire harness 30 is provided with a wire bundle 40. The wire bundle 40 has a plurality of electrical wires 41. For example, the wire bundle 40 has four wires 41. The four wires 41 are, for example, the same type of wire, and have equal diameters. The wire bundle 40 is formed by the plurality of wires 41 being bundled together.

As shown in FIG. 2, each wire 41 has a core wire 42 that has conductivity and an insulating coating 43 that surrounds the outer periphery of the core wire 42 and has insulating properties. Note that FIG. 2 is a sectional view taken along line 2-2 in FIG. 1.

As the core wire 42, for example, a twisted wire formed by twisting a plurality of metal wires together, a columnar conductor constituted by one columnar metal rod having an internally solid structure, or a tubular conductor having an internally hollow structure may be used. Also, as the core wire 42, for example, a combination of at least two of the twisted wire, the columnar conductor and the tubular conductor may be used. As the material of the core wire 42, for example, a metal material such as a copper-based or aluminum-based material can be used.

The insulating coating 43 covers, for example, the outer periphery of the core wire 42 around its entirety in the circumferential direction about a center line L1 of the wire 41. The insulating coating 43 is constituted by, for example, a resin material that has insulating properties.

Note that, in FIGS. 1 and 2, the center lines L1 of the wires 41 are illustrated by dash-dotted lines. The center line L1 is a line passing through the center of a transverse section of the wire 41.

A connector (not shown) is provided at an end portion of each wire 41. The connector has a connector housing and a connection terminal that is held on the inner side of the connector housing. The plurality of wires 41 are each electrically connected to a different connection terminal.

The wire bundle 40 has a flat part 45 in which the plurality of wires 41 are lined up flat in at least part thereof in the direction in which the wire bundle 40 extends. For example, the wire bundle 40 has the flat part 45 in part of the wire bundle 40.

For example, in the flat part 45, the four wires 41 are lined up in a row in a direction that perpendicularly intersects the direction in which the wire bundle 40 extends. Note that the direction in which the wire bundle 40 extends will be referred to below as an extension direction X. The extension direction X is the length direction of the wire bundle 40 and is the direction along the center lines L1 of the bundled plurality of wires 41. In the drawings, the extension direction X is shown by a two-way arrow.

In the flat part 45, the plurality of wires 41 are lined up in a first direction Y that perpendicularly intersects the extension direction X. The direction that perpendicularly intersects the extension direction X and perpendicularly intersects the first direction Y will be given as a second direction Z. The first direction Y corresponds to a width direction of the flat part 45. The second direction Z corresponds to a thickness direction of the flat part 45. The traverse sectional shape of the flat part 45 is long in the first direction Y and thin and flat in the second direction Z. Note that the “traverse section” is a cross section cut in a plane perpendicular to the extension direction X. Also, the width of the flat part 45 in the first direction Y is greater than the width of the flat part 45 in the second direction Z. In the flat part 45, the four wires 41 extend parallel to each other, for example. Also, in the flat part 45, the wires 41 adjacent in the first direction Y are in contact with each other, for example.

Note that, herein, “a plurality of wires are lined up flat” means that a plurality of wires are lined up such that the traverse sectional shape of the wire bundle is flat in shape. That is, it means that the wires are lined up such that the traverse sectional shape of the wire bundle is long in a first direction that perpendicularly intersects the direction in which the wire bundle extends, and is thin in a second direction that perpendicularly intersects the first direction. The width of the flat part in the first direction corresponds to the width of the widest portion in the traverse section of the flat part. Furthermore, the width of the flat part in the first direction and the width of the flat part in the second direction are different values, with the width of the flat part in the first direction being greater than the width of the flat part in the second direction. Also, herein, “a flat state” means a state where the plurality of wires are lined up flat.

The wire harness 30 is provided with a first tape member 50 and a second tape member 60. The first tape member 50 and the second tape member 60 are affixed together with the flat part 45 sandwiched therebetween from both sides in the thickness direction of the flat part 45. The wires 41 in the flat part 45 are integrally held by the first tape member 50 and the second tape member 60.

The first tape member 50 is, for example, band shaped. The first tape member 50 has, for example, a band-shaped first substrate 51. Also, the first tape member 50 has, for example, a first adhesive layer 52 laminated on one surface of the first substrate 51.

The first tape member 50 is, for example, protective tape. In the case where the first tape member 50 is protective tape, the first substrate 51 is greater in thickness than, for example, the substrate included in wire bundling tape that is generally used for bundling wires. Also, in this same case, the first substrate 51 has a higher hardness than, for example, the substrate of wire bundling tape generally used. For example, the first substrate 51 is made of a material having a higher Vickers hardness value than the substrate of wire bundling tape generally used.

In the case where the first tape member 50 is protective tape, polypropylene (PP) tape can be used as the first tape member 50. In the case where the first tape member 50 is PP tape, the first substrate 51 is, for example, one of a band-shaped PP film and a woven fabric in which PP fibers are woven in a band shape. Note that, in the case where the first tape member 50 is protective tape, any of acetate tape, polycarbonate tape and polyethylene (PE) tape can be used as the first tape member 50.

The second tape member 60 is, for example, band shaped. The second tape member 60 has, for example, a band-shaped second substrate 61. Also, the second tape member 60 has, for example, a second adhesive layer 62 laminated on one surface of the second substrate 61. The second tape member 60 is, for example, the same type of tape member as the first tape member 50. In the present embodiment, since the first tape member 50 and the second tape member 60 are the same type of tape member, detailed description of the second tape member 60 will be omitted.

The first tape member 50 and the second tape member 60 are affixed together with the flat part 45 sandwiched therebetween from both sides in the thickness direction of the flat part 45, such that the first adhesive layer 52 and the second adhesive layer 62 oppose each other with the flat part 45 sandwiched therebetween. In addition, the first tape member 50 and the second tape member 60 each extend in the extension direction X, for example. Also, the flat part 45 is maintained in a straight state by, for example, the first tape member 50 and the second tape member 60, as seen in the width direction of the flat part 45.

The first tape member 50 and the second tape member 60 may be directly affixed to each other on both sides in the width direction of the flat part 45, for example. For example, the first tape member 50 and the second tape member 60 each have a length in the width direction of the flat part 45 that is greater than the flat part 45. In addition, the first tape member 50 and the second tape member 60 may have, on each side in the width direction of the flat part 45, a first sticking edge portion 53 and a second sticking edge portion 63 that are directly affixed to each other. The first tape member 50 has, for example, a first sticking edge portion 53 in an edge region of both edges of the first tape member 50 in the width direction. The second tape member 60 has, for example, a second sticking edge portion 63 in an edge region of both edges of the second tape member 60 in the width direction. In the wire harness 30, the flat part 45 is located between the two sets of the first sticking edge portion 53 and the second sticking edge portion 63 that are affixed to each other. The first sticking edge portion 53 and the second sticking edge portion 63 each extend in the extension direction X.

Also, at least one of the first tape member 50 and the second tape member 60 may be adhered to at least part of the outer peripheral surface of at least one of the wires 41 that are located between the first tape member 50 and the second tape member 60.

For example, the first tape member 50 is adhered to part of the outer peripheral surface of each of the four wires 41 that are located between the first tape member 50 and the second tape member 60. That is, the first adhesive layer 52 of the first tape member 50 is in contact with part of the outer peripheral surface of each of the four wires 41 that are located between the first tape member 50 and the second tape member 60. In addition, for example, the first adhesive layer 52 of the first tape member 50 is in intimate contact with part of the outer peripheral surface of each of the four wires 41 that are located between the first tape member 50 and the second tape member 60.

For example, the second tape member 60 is adhered to part of the outer peripheral surface of each of the four wires 41 that are located between the first tape member 50 and the second tape member 60. That is, the second adhesive layer 62 of the second tape member 60 is in contact with part of the outer peripheral surface of each of the four wires 41 that are located between the first tape member 50 and the second tape member 60. In addition, for example, the second adhesive layer 62 of the second tape member 60 is in intimate contact with part of the outer peripheral surface of each of the four wires 41 that are located between the first tape member 50 and the second tape member 60.

Also, at least one of the first tape member 50 and the second tape member 60 may have a circular-arc sticking portion (54, 64) that is circular arc shaped extending around the outer peripheral surface of at least one of the wires 41 located between the first tape member 50 and the second tape member 60 and adheres to the outer peripheral surface thereof.

For example, the first tape member 50 has two first circular-arc sticking portions 54 that are circular arc shaped extending around the outer peripheral surfaces of the two wires 41 respectively arranged at both edges in the flat part 45, out of the wires 41 that are located between the first tape member 50 and the second tape member 60, and adhere to the outer peripheral surfaces thereof. The first adhesive layers 52 of the two first circular-arc sticking portions 54 are respectively in surface contact with part of the outer peripheral surfaces of the two wires 41 arranged at both edges in the flat part 45. In addition, for example, the first adhesive layers 52 in the two first circular-arc sticking portions 54 are respectively in intimate contact with part of the outer peripheral surfaces of the two wires 41 arranged at both edges in the flat part 45.

For example, the second tape member 60 has two second circular-arc sticking portions 64 that are circular arc shaped extending around the outer peripheral surfaces of the two wires 41 respectively arranged at both edges in the flat part 45, out of the wires 41 that are located between the first tape member 50 and the second tape member 60, and are stuck to the outer peripheral surfaces thereof. The second adhesive layers 62 of the two second circular-arc sticking portions 64 are respectively in surface contact with part of the outer peripheral surfaces of the two wires 41 arranged at both edges in the flat part 45. For example, the second adhesive layers 62 of the two second circular-arc sticking portions 64 are respectively in intimate contact with part of the outer peripheral surfaces of the two wires 41 arranged at both edges in the flat part 45.

Operation of the present embodiment will now be described.

The first tape member 50 and the second tape member 60 restrict relative movement of the wires 41 in the flat part 45 and movement of the wires 41 with respect to the first tape member 50 and the second tape member 60. That is, movement of the wires 41 between the first tape member 50 and the second tape member 60 that increases the thickness of the flat part 45 is restricted.

The effects of the present embodiment will now be described.

(1-1) By affixing the first tape member 50 and the second tape member 60 together, the flat part 45 sandwiched between the first tape member 50 and the second tape member 60 can be maintained in a state where the plurality of wires 41 are lined up flat. Accordingly, the plurality of wires 41 in the flat part 45 can be easily maintained in a flat state by the first tape member 50 and the second tape member 60.

(1-2) The first tape member 50 and the second tape member 60 are each band shaped and extend in the extension direction X. According to this configuration, the plurality of wires 41 in the flat part 45 can be easily maintained in a flat state throughout the region in which the first tape member 50 and the second tape member 60 are affixed together in the extension direction X.

(1-3) The first tape member 50 and the second tape member 60 are directly affixed to each other on both sides in the width direction of the flat part 45. According to this configuration, movement of the second tape member 60 relative to the first tape member 50 is suppressed. Accordingly, the plurality of wires 41 in the flat part 45 are more easily maintained in a flat state by the first tape member 50 and the second tape member 60. Also, the outer periphery of the flat part 45 can be surrounded around its entirety by the first tape member 50 and the second tape member 60. Accordingly, when the wire harness 30 is routed, peripheral members or the like coming in direct contact with the flat part 45 can be suppressed by the first tape member 50 and the second tape member 60. In other words, the wire harness 30 can be protected.

(1-4) The first tape member 50 and the second tape member 60 are each adhered to at least part of the outer peripheral surface of the wires 41 that are located between the first tape member 50 and the second tape member 60. According to this configuration, the plurality of wires 41 in the flat part 45 are even more easily maintained in a flat state.

(1-5) The first tape member 50 has the first circular-arc sticking portions 54 that are circular arc shaped extending around the outer peripheral surfaces of the two wires 41 respectively located at both edges in the width direction of the flat part 45, out of the wires 41 that are located between the first tape member 50 and the second tape member 60, and adhere to the outer peripheral surfaces thereof. The second tape member 60 has the second circular-arc sticking portions 64 that are circular arc shaped extending around the outer peripheral surfaces of the two wires 41 respectively located at both edges in the width direction of the flat part 45, out of the wires 41 that are located between the first tape member 50 and the second tape member 60, and adhere to the outer peripheral surfaces thereof. According to this configuration, the plurality of wires 41 in the flat part 45 are still even more easily maintained in a flat state.

(1-6) The first tape member 50 and the second tape member 60 are each protective tape. The first tape member 50 has the band-shaped first substrate 51 and the first adhesive layer 52 laminated on one surface of the first substrate 51. The second tape member 60 has the band-shaped second substrate 61 and the second adhesive layer 62 laminated on one surface of the second substrate 61. In the case where the first tape member 50 and the second tape member 60 are each protective tape, the first substrate 51 and the second substrate 61 are each greater in thickness than the substrate included in wire bundling tape that is used for bundling wires. Accordingly, the protective tape is less likely to tear, compared with wire bundling tape. Accordingly, by using protective tape as the first tape member 50 and the second tape member 60, the portion of the flat part 45 that is covered by the first tape member 50 and the second tape member 60 can be protected from peripheral members by the first tape member 50 and the second tape member 60.

(1-7) The protective tape that is used as the first tape member 50 and the second tape member 60 is polypropylene tape. According to this configuration, the protective tape that is used as a material of the first tape member 50 and the second tape member 60 can be readily obtained.

(1-8) The first tape member 50 and the second tape member 60 are the same type of tape member. According to this configuration, preparation of the first tape member 50 and the second tape member 60 is facilitated, compared with the case where the first tape member 50 and the second tape member 60 are different types of tape member. In addition, the first tape member 50 may also be disposed on either side in the thickness direction of the flat part 45. Accordingly, the problem of erroneously affixing the first tape member 50 and the second tape member 60 to the flat part 45 no longer arises, thus enabling productivity of the wire harness 30 to be improved.

(1-9) The flat part 45 is maintained in a straight state by the first tape member 50 and the second tape member 60, as seen in the width direction of the flat part 45. According to this configuration, in the case where the routing location of the flat part 45 is straight, the flat part 45 can be easily routed.

(1-10) The plurality of wires 41 in the flat part 45 are maintained in a flat state due to the first tape member 50 and the second tape member 60 being adhered to both sides of the flat part 45 in the thickness direction of the flat part 45. Thus, the plurality of wires 41 in the flat part 45 coming loose is suppressed. Accordingly, the wire harness 30 can be routed more easily.

(1-11) A conventional wire flattening member constituted by a resin molded article is not used, in order to maintain the plurality of wires 41 in the flat part 45 in a flat state. The plurality of wires 41 in the flat part 45 are maintained in a flat state by the band-shaped first tape member 50 and second tape member 60. Accordingly, the flat part 45 and the portion of the wire harness 30 peripheral the flat part 45 can be made thinner, compared with the case of using a conventional wire flattening member.

Also, the length in the extension direction X and the width in the first direction Y of the first tape member 50 and the second tape member 60 can be easily changed, compared with a conventional wire flattening member constituted by a resin molded article. Thus, a person handling the first tape member 50 and the second tape member 60 can make fine adjustments to the length and profile of the first tape member 50 and the second tape member 60 at any location such as, for example, the place of manufacture of the wire harness 30.

Also, a conventional wire flattening member constituted by a resin molded article is generally formed using a mold. The mold for forming the wire flattening member has a shape that depends on the diameter and number of wires provided in the wire harness. Thus, when the diameter or number of wires provided in the wire harness is changed, the shape of the mold for forming the wire flattening member also changes. Accordingly, there is a problem in that manufacturing costs increase. On the other hand, the first tape member 50 and the second tape member 60 are each formed by tape such as protective tape. Accordingly, even if the diameter or number of wires 41 that are provided in the wire harness 30 is changed, a mold does not need to be newly manufactured, thus enabling an increase in manufacturing costs to be suppressed. Also, commercially available tape can be used as the first tape member 50 and the second tape member 60. Accordingly, even if the diameter or number of wires 41 provided in the wire harness 30 is changed, tape that is used as the first tape member 50 and the second tape member 60 can be easily prepared.

### Second Embodiment

Hereinafter, a second embodiment of a wire harness will be described. Note that, in this second embodiment, the same reference numerals are given to configuration that is the same as or corresponds to the above first embodiment, and description thereof will be partially or wholly omitted.

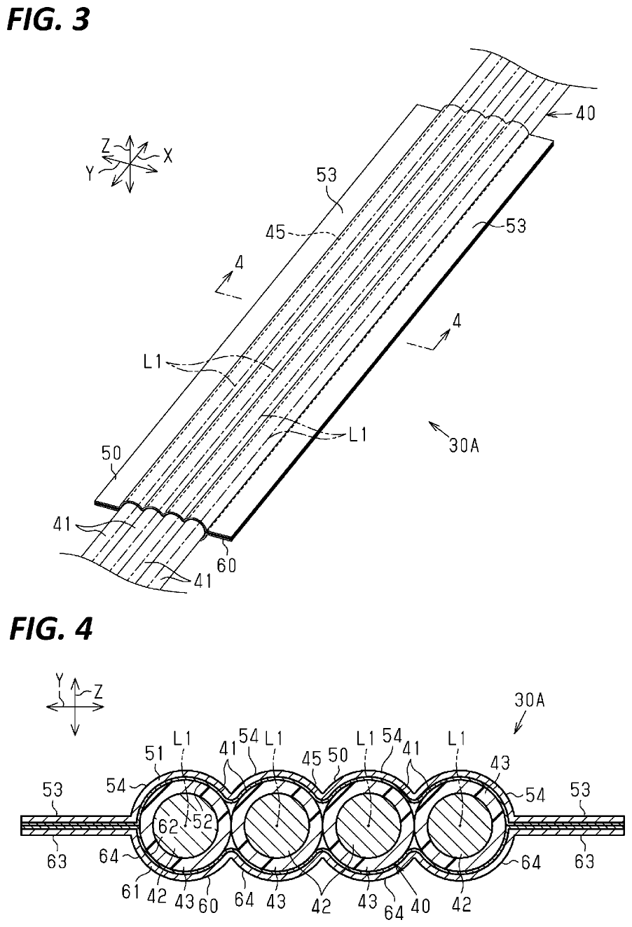

As shown in FIGS. 3 and 4, a wire harness 30A of this second embodiment is provided with a wire bundle 40 having a flat part 45, a first tape member 50, and a second tape member 60. Note that FIG. 4 is a sectional view taken along line 4-4 in FIG. 3.

The first tape member 50 has four first circular-arc sticking portions 54 that adhere to the outer peripheral surface of four electrical wires 41 that are located between the first tape member 50 and the second tape member 60. The four first circular-arc sticking portions 54 are lined up in the first direction Y, that is, in the width direction of the flat part 45, between two first sticking edge portions 53. Also, the four first circular-arc sticking portions 54 are lined up continuously in the width direction of the flat part 45.

First adhesive layers 52 of the four first circular-arc sticking portions 54 are respectively in surface contact with part of the outer peripheral surfaces of the four wires 41 of the flat part 45. In addition, for example, the first adhesive layers 52 of the four first circular-arc sticking portions 54 are respectively in intimate contact with part of the outer peripheral surfaces of the four wires 41 of the flat part 45. Also, the first circular-arc sticking portions 54 are circular arc shaped extending along the outer peripheral surfaces of the wires 41. Furthermore, the first circular-arc sticking portions 54 extend in the extension direction X.

A second tape member 60 also similarly has four second circular-arc sticking portions 64. Note that since the four second circular-arc sticking portions 64 have a similar configuration as the four first circular-arc sticking portions 54, description of the four second circular-arc sticking portions 64 will be omitted.

According to this second embodiment, similar operation to the above first embodiment is achieved. Furthermore, in the flat part 45, the first circular-arc sticking portions 54 and the second circular-arc sticking portions 64 respectively adhere to each of the wires 41. Accordingly, relative movement between the wires 41 is suppressed in the flat part 45.

According to this second embodiment, the following effect is achieved, in addition to similar effects to the above first embodiment.

(2-1) The first tape member 50 and the second tape member 60 respectively have the circular-arc sticking portions 54 and 64 that are circular arc shaped extending around the outer peripheral surfaces of the wires 41 located between the first tape member 50 and the second tape member 60 and adhere to the outer peripheral surfaces thereof. According to this configuration, the plurality of wires 41 in the flat part 45 are still even more easily maintained in a flat state.

### Third Embodiment

Hereinafter, a third embodiment of a wire harness will be described. Note that, in this third embodiment, the same reference numerals are given to configuration that is the same as or corresponds to the above first embodiment or the above second embodiment, and description thereof will be partially or wholly omitted.

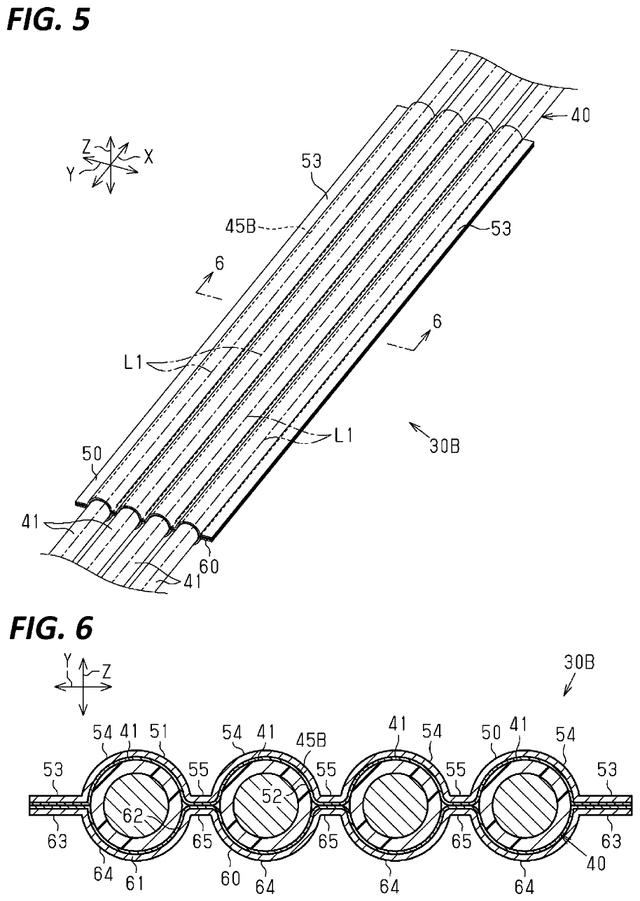

As shown in FIGS. 5 and 6, a wire harness 30B of this third embodiment is provided with a wire bundle 40 having a flat part 45B, a first tape member 50, and a second tape member 60. Note that FIG. 6 is a sectional view taken along line 6-6 in FIG. 5.

For example, the wire bundle 40 has the flat part 45B in which a plurality of electrical wires 41 are lined up flat in part thereof in the direction in which the wire bundle 40 extends. In the flat part 45B, the plurality of wires 41 are lined up in the first direction Y that perpendicularly intersects the extension direction X. The traverse sectional shape of the flat part 45B is long in the first direction Y and thin and flat in the second direction Z. Also, in the flat part 45B, the four wires 41 extend parallel to each other, for example. Also, in the flat part 45, the wires 41 adjacent in the first direction Y are spaced apart from each other in the first direction Y, that is, in the width direction of the flat part 45.

The first tape member 50 and the second tape member 60 are directly affixed to each other between adjacent wires 41 in the flat part 45B. To be precise, the first tape member 50 and the second tape member 60 respectively have a first inter-wire sticking portion 55 and a second wire sticking portion 65 that are directly affixed to each other between wires 41 adjacent in the width direction of the flat part 45. The first inter-wire sticking portion 55 and the second inter-wire sticking portion 65 each extend in the extension direction X.

In the flat part 45B of the wire harness 30B, the portions in which the first inter-wire sticking portion 55 and the second inter-wire sticking portion 65 are affixed to each other are located between the four wires 41. The first tape member 50 and the second tape member 60, by having the first inter-wire sticking portions 55 and the second inter-wire sticking portions 65, maintain the plurality of wires 41 in the flat part 45B in a state of being spaced apart from each other in the width direction of the flat part 45.

Also, the first tape member 50 has two first sticking edge portions 53 and four first circular-arc sticking portions 54. In the first tape member 50, the first circular-arc sticking portions 54 are respectively located on both sides of each first wire sticking portion 55 in the width direction of the flat part 45B. Similarly, the second tape member 60 has two second sticking edge portions 63 and four second circular-arc sticking portions 64. In the second tape member 60, the second circular-arc sticking portions 64 are respectively located on both sides of each second wire sticking portion 65 in the width direction of the flat part 45B. In the flat part 45B, the outer periphery of each wire 41 is surrounded around its entirety by the first tape member 50 and the second tape member 60.

According to this third embodiment, operation is similar to the above first embodiment and the above second embodiment. Furthermore, due to the first tape member 50 and the second tape member 60 respectively having the first inter-wire sticking portions 55 and the second inter-wire sticking portions 65, the state where the wires 41 adjacent in the width direction of the flat part 45B are spaced apart from each other in the width direction of the flat part 45B can be maintained in the flat part 45B.

Also, due to the first tape member 50 and the second tape member 60 having the first inter-wire sticking portions 55 and the second wire sticking portions 65, the outer peripheral surfaces of the wires 41 in the flat part 45B are entirely covered by the first circular-arc sticking portions 54 and the second circular-arc sticking portions 64. Accordingly, in the flat part 45B, an air layer is unlikely to be formed between the outer peripheral surface of the wires 41 and the first tape member 50 and between the outer peripheral surface of the wires 41 and the second tape member 60.

According to this third embodiment, the following effect is achieved, in addition to similar effects to the above first embodiment and the effect (2-1) of the above second embodiment.

(3-1) The first tape member 50 and the second tape member 60 are directly affixed to each other between adjacent wires 41 in the flat part 45B. According to this configuration, in the flat part 45B, the plurality of wires 41 are maintained in a state of being spaced apart from each other in the width direction of the flat part 45B by the first tape member 50 and the second tape member 60. Thus, the surface area of the portion in which the first tape member 50 and the second tape member 60 cover the wires 41 can be increased, compared with the case where the wires 41 adjacent in the width direction of the flat part 45B are in contact with each other. Accordingly, heat dissipation in the flat part 45B can be improved.

Also, in the flat part 45B, when the wires 41 adjacent in the width direction of the flat part 45B are maintained in a state of being spaced apart from each other in the width direction of the flat part 45B, frictional force is unlikely to occur between the wires 41 when the flat part 45B is bent. The flat part 45B is thus easily bent. Accordingly, in the case where the first tape member 50 and the second tape member 60 each have superior flexibility to the wires 41, the flexibility of the flat part 45B can be improved.

### Fourth Embodiment

Hereinafter, a fourth embodiment of a wire harness will be described. Note that, in this fourth embodiment, the same reference numerals are given to configuration that is the same as or corresponds to the above first embodiment, and description thereof will be partially or wholly omitted.

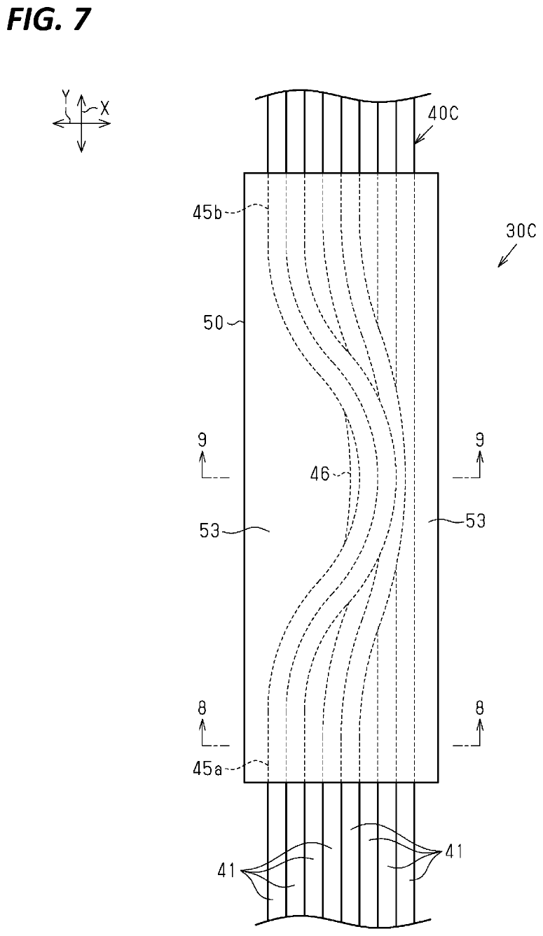

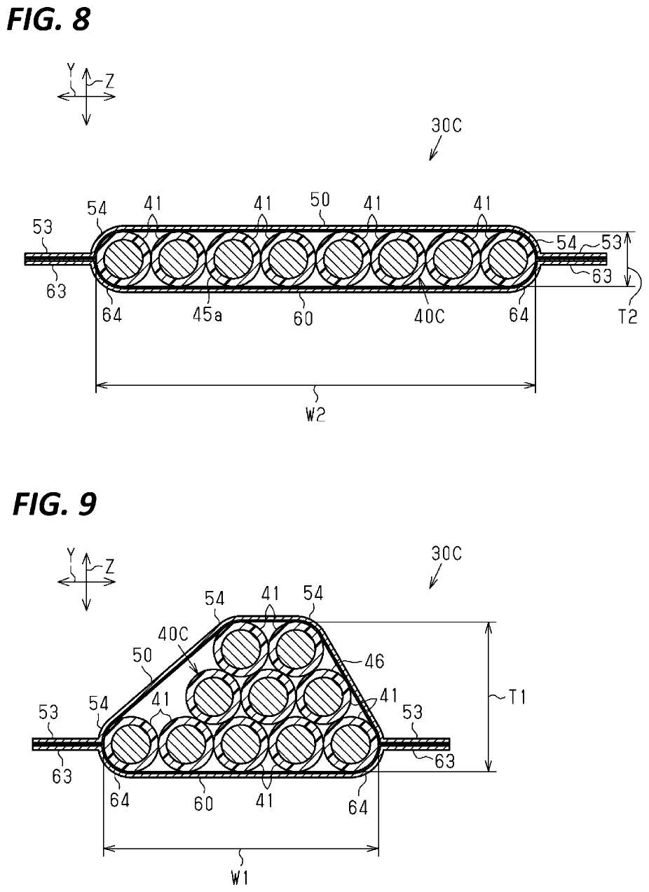

A wire harness 30C of this fourth embodiment shown in FIGS. 7 to 9 is provided with a wire bundle 40C, a first tape member 50, and a second tape member 60. Note that FIG. 8 is a sectional view taken along line 8-8 in FIG. 7. FIG. 9 is a sectional view taken along line 9-9 in FIG. 7.

The wire bundle 40C has, for example, eight electrical wires 41. The eight wires 41 are, for example, the same type of wire, and have equal diameters.

The wire bundle 40C has two flat parts 45a and 45b. In each of the flat parts 45a and 45b, the eight wires 41 are lined up in a row in the first direction Y similarly to the flat part 45 of the above first embodiment. The flat part 45a and the flat part 45b are spaced apart from each other in the extension direction X.

Also, the wire bundle 40 has a stacked part 46 that is located between the two flat parts 45a and 45b in the extension direction X. In the stacked part 46, the wires 41 are arranged in a different manner from the wires 41 in the flat parts 45a and 45b. The plurality of wires 41 in the stacked part 46 are arranged such that the stacked part 46 is greater in thickness than either the flat part 45a or 45b in the thickness direction of the flat parts 45a and 45b. Moreover, the plurality of wires 41 in the stacked part 46 are arranged such that the stacked part 46 is narrower in width than either the flat part 45a or 45b in the width direction of the flat part 45. Accordingly, a thickness T1 of the stacked part 46 in the thickness direction of the flat parts 45a and 45b, that is, in the second direction Z, is greater than a thickness T2 of the flat part 45a in the second direction Z. Furthermore, a width W1 of the stacked part 46 in the width direction of the flat parts 45a and 45b, that is, in the first direction Y, is narrower than a width W2 of the flat part 45a in the first direction Y. Also, the thickness T1 of the stacked part 46 in the second direction Z is greater than the thickness of the flat part 45b in the second direction Z. Furthermore, the width W1 of the stacked part 46 in the first direction Y is narrower than the width of the flat part 45b in the first direction Y.

Note that the thickness T2 of the flat part 45a in the second direction Z and the thickness of the flat part 45b in the second direction Z are, for example, the same thickness. Also, the width W2 of the flat part 45a in the first direction Y and the width of the flat part 45b in the second direction Z are, for example, the same width. The thickness T2 of the flat part 45a in the second direction Z and the thickness of the flat part 45b in the second direction Z may, however, be different thicknesses. Also, the width W2 of the flat part 45a in the first direction Y and the width of the flat part 45b in the second direction Z may be different widths.

In each of the flat parts 45a and 45b, the eight wires 41 are lined up in a row, that is, in one layer, in the first direction Y. In contrast, in the stacked part 46, the eight wires 41 are arranged in a stacked manner in the second direction Z. For example, in part of the stacked part 46, there are three rows of wires 41 lined up in the first direction Y. Also, in part of the stacked part 46, the wires 41 lined up in the first direction Y are stacked in three layers in the second direction Z.

The two flat parts 45a and 45b and the stacked part 46 are sandwiched between the first tape member 50 and the second tape member 60. The first tape member 50 and the second tape member 60 are affixed together with the flat parts 45a and 45b and the stacked part 46 sandwiched therebetween from both sides in the thickness direction of the flat parts 45a and 45b.

According to this fourth embodiment, similar operation to the above first embodiment is achieved. Furthermore, the portions of the plurality of wires 41 in the stacked part 46 that come in contact with the first tape member 50 and the second tape member 60 can be reduced, compared with the plurality of wires 41 in the flat parts 45a and 45b.

According to this fourth embodiment, the following effect is achieved, in addition to similar effects to the above first embodiment.

(4-1) The wire bundle 40C has the two flat parts 45a and 45b that are spaced apart from each other in the extension direction X, and the stacked part 46 that is located between the two flat parts 45a and 45b in the extension direction X and in which the wires 41 are arranged in a different manner from the wires 41 in the flat parts 45a and 45b. The two flat parts 45a and 45b and the stacked part 46 are sandwiched between the first tape member 50 and the second tape member 60. The plurality of wires 41 in the stacked part 46 are arranged such that the stacked part 46 is greater in thickness than the flat parts 45a and 45b in the thickness direction of the flat parts 45a and 45b, and is narrower in width than the flat parts 45a and 45b in the width direction of the flat part 45.

According to this configuration, the plurality of wires 41 in the stacked part 46 have fewer portions in contact with the first tape member 50 and the second tape member 60, compared with the plurality of wires 41 in the flat parts 45a and 45b. Thus, the stacked part 46 is bent more easily compared with the flat parts 45a and 45b. Accordingly, the stacked part 46 that is located between the two flat parts 45a and 45b can be easily bent to route the wire harness 30C. In other words, the wire harness 30C can be provided with flexibility.

### Fifth Embodiment

Hereinafter, a fifth embodiment of a wire harness will be described. Note that, in this fifth embodiment, the same reference numerals are given to configuration that is the same as or corresponds to the above first embodiment, and description thereof will be partially or wholly omitted.

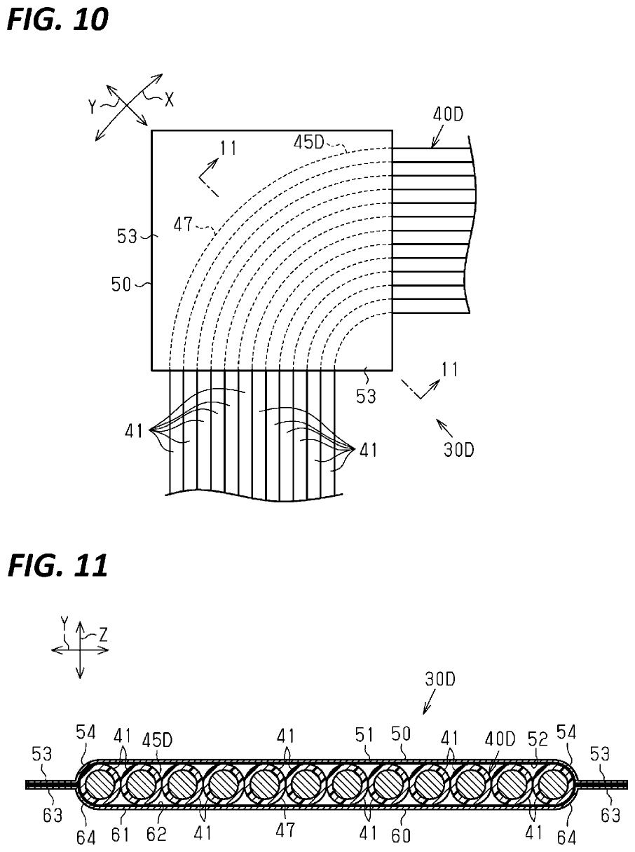

A wire harness 30D of this fifth embodiment shown in FIGS. 10 and 11 is provided with a wire bundle 40D, a first tape member 50, and a second tape member 60. Note that FIG. 11 is a sectional view taken along line 11-11 in FIG. 10.

The wire bundle 40D has, for example, twelve electrical wires 41. The twelve wires 41 are, for example, the same type of wire and have equal diameters.

The wire bundle 40D has a flat part 45D in which the plurality of wires 41 are lined up flat in part thereof in the extension direction X. The flat part 45D has a flat bent portion 47 in which the plurality of wires 41 bend, as seen in the thickness direction of the flat part 45D.

The plurality of wires 41 in the flat bent portion 47 are lined up in a row in the width direction of the flat part 45D, and bend while maintaining the arrangement of being lined up in a row as seen in the thickness direction of the flat part 45D. The plurality of wires 41 in the flat bent portion 47 are aligned such that the length of the wires 41 in the flat bent portion 47 gradually increases from the wire 41 located at one edge in the width direction of the flat bent portion 47 to the wire 41 located at the other edge. For example, the twelve wires 41 in the flat bent portion 47 are concentrically curved in a circular arc shape as seen in the thickness direction of the flat part 45D. In addition, the radius of curvature of the plurality of wires 41 in the flat bent portion 47 gradually increases from the wire 41 located at one edge in the width direction of the flat bent portion 47 to the wire 41 located at the other edge. Note that the twelve wires 41 in the flat bent portion 47 all curve with different curvatures. Also, in the flat bent portion 47, the wires 41 adjacent in the width direction of the flat part 45D are, for example, in contact with each other.

The first tape member 50 and the second tape member 60 sandwich the flat bent portion 47 from both sides in the thickness direction of the flat part 45D. Furthermore, the first tape member 50 and the second tape member 60 maintain the arrangement and bent shape of the plurality of wires 41 in the flat bent portion 47. For example, the first tape member 50 and the second tape member 60 maintain the arrangement and bent shape of the plurality of wires 41 in the flat bent portion 47, by the adhesive force of the first adhesive layer 52 and the second adhesive layer 62, and also with the first substrate 51 and the second substrate 61.

According to this fifth embodiment, similar operation to the above first embodiment is achieved. Furthermore, the portion in which the plurality of wires 41 bend in the wire bundle 40D can be maintained in a bent shape as well as in a flat state, by the first tape member 50 and the second tape member 60.

According to this fifth embodiment, the following effect is achieved, in addition to similar effects to the above first embodiment.

(5-1) The flat part 45D has the flat bent portion 47 in which the plurality of wires 41 bend as seen in the thickness direction of the flat part 45D. The plurality of wires 41 in the flat bent portion 47 are lined up in a row in the width direction of the flat part 45D, and bend while maintaining the arrangement of being lined up in a row as seen in the thickness direction of the flat part 45. The first tape member 50 and the second tape member 60 sandwich the flat bent portion 47 from both sides in the thickness direction of the flat part 45D, and maintain the arrangement and bent shape of the plurality of wires 41 in the flat bent portion 47.

According to this configuration, the portion in which the plurality of wires 41 bend in the wire bundle 40D can also be maintained in a flat state by the first tape member 50 and the second tape member 60. Accordingly, even if the routing location of the flat part 45D is narrow and bends, the flat part 45D can be disposed in the routing location.

### Sixth Embodiment

Hereinafter, a sixth embodiment of a wire harness will be described. Note that, in this sixth embodiment, the same reference numerals are given to configuration that is the same as or corresponds to the above first embodiment, and description thereof will be partially or wholly omitted.

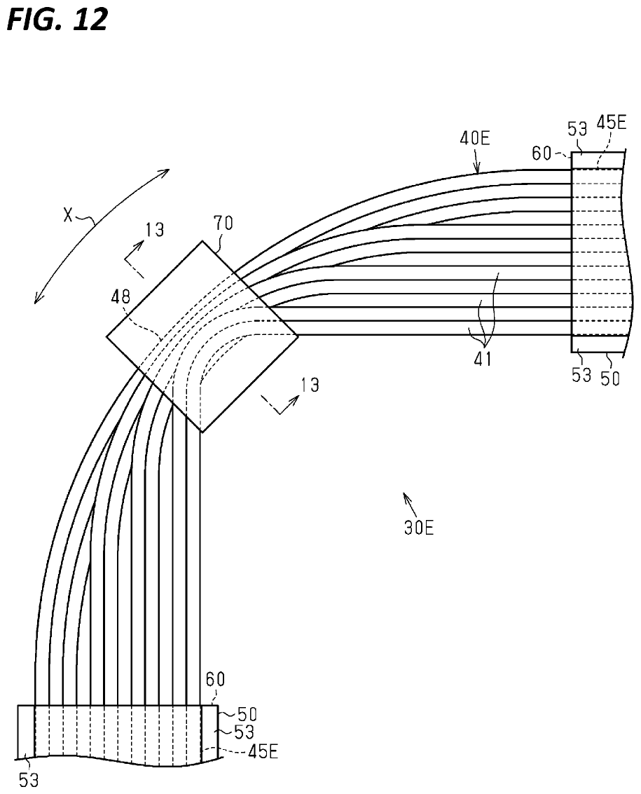

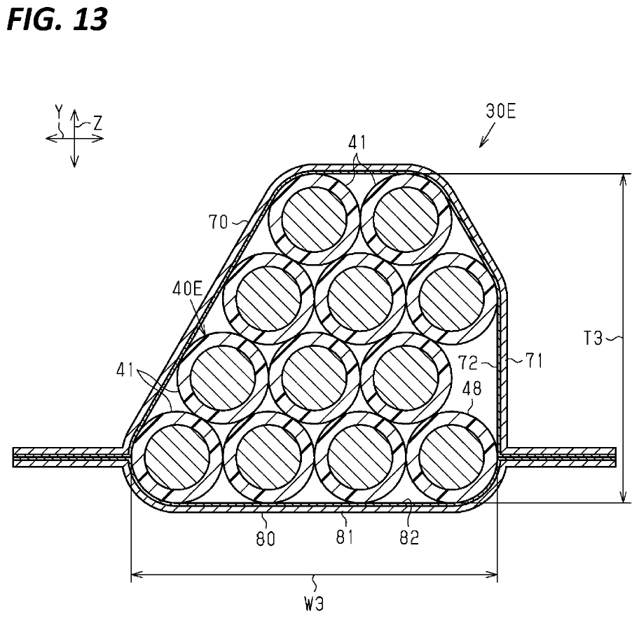

A wire harness 30E of this sixth embodiment shown in FIGS. 12 and 13 has a wire bundle 40E. Note that FIG. 13 is a sectional view taken along line 13-13 in FIG. 12. The wire bundle 40E has, for example, twelve electrical wires 41. The twelve wires 41 are, for example, the same type of wire and have equal diameters.

The wire bundle 40E has, for example, two flat parts 45E in which the plurality of wires 41 are lined up flat in part thereof in the extension direction X. Note that the wire bundle 40E may have only one flat part 45E. Although the number of wires 41 differ, the flat parts 45E have a similar configuration to the flat part 45 of the above first embodiment. The two flat parts 45E are located at two locations in the wire bundle 40E that are spaced apart from each other in the extension direction X. Note that the thicknesses of the two flat parts 45E in the second direction Z are, for example, the same thickness. Also, the widths of the two flat parts 45E in the first direction Y are, for example, the same width.

Each flat part 45E is sandwiched by the first tape member 50 and the second tape member 60 from both sides in the thickness direction of the flat parts 45E. That is, the wire harness 30E is provided with two sets of the first tape member 50 and the second tape member 60.

The wire bundle 40E has a stacked bent part 48 in which the wire bundle 40E bends at a position shifted from the flat parts 45E in the extension direction X. The wire bundle 40E has, for example, the stacked bent part 48 between the two flat parts 45E in the extension direction X.

In the stacked bent part 48, the wires 41 are arranged in a different manner from the wires 41 in the flat parts 45E. In the stacked bent part 48, the plurality of wires 41 are stacked in the thickness direction of the flat parts 45E. The plurality of wires 41 in the stacked bent part 48 bend in an overlapping state such that the stacked bent part 48 is greater in thickness than the flat parts 45E in the thickness direction of the flat parts 45E. Moreover, the plurality of wires 41 in the stacked bent part 48 bend in an overlapping state such that the stacked bent part 48 is narrower in width than the flat parts 45E in the width direction of the flat parts 45E. Accordingly, a thickness T3 of the stacked bent part 48 in the thickness direction of the flat parts 45E, that is, in the second direction Z, is greater than the thickness of the flat parts 45E in the second direction Z. Furthermore, a width W3 of the stacked bent part 48 in the width direction of the flat parts 45E, that is, in the first direction Y, is narrower than the width of the flat parts 45E in the first direction Y. Note that the thickness T3 and width W3 of the stacked bent part 48 are compared with the thickness and width of the flat part 45E located closest to the stacked bent part 48 in the wire bundle 40E.

The wire harness 30E is provided with a first bend fixing tape member 70 and a second bend fixing tape member 80 that are affixed together with the stacked bent part 48 sandwiched therebetween. The first bend fixing tape member 70 has a sheet-like first substrate 71 and a first adhesive layer 72 laminated on one surface of the first substrate 71. The second bend fixing tape member 80 has a sheet-like second substrate 81 and a second adhesive layer 82 laminated on one surface of the second substrate 81. The first bend fixing tape member 70 and the second bend fixing tape member 80 are affixed to each other with the stacked bent part 48 sandwiched therebetween in a state where the first adhesive layer 72 and the second adhesive layer 82 oppose each other.

The first bend fixing tape member 70 and the second bend fixing tape member 80 maintain the arrangement and bent shape of the plurality of wires 41 in the stacked bent part 48. For example, the first bend fixing tape member 70 and the second bend fixing tape member 80 maintain the arrangement and bent shape of the plurality of wires 41 in the stacked bent part 48, by the adhesive force of the first adhesive layer 72 and the second adhesive layer 82, and also with the first substrate 71 and the second substrate 81.

According to this sixth embodiment, similar operation to the above first embodiment is achieved. Furthermore, in the wire bundle 40E having the flat parts 45E, the portion in which the plurality of wires 41 bend, that is, the stacked bent part 48, can be maintained in the bent shape by the first bend fixing tape member 70 and the second bend fixing tape member 80.

According to this sixth embodiment, the following effect is achieved, in addition to similar effects to the above first embodiment.

(6-1) The wire bundle 40E has the stacked bent part 48 in which the wire bundle 40E bends at a position shifted from the flat parts 45E in the extension direction X. The plurality of wires 41 in the stacked bent part 48 bend in an overlapping state such that the stacked bent part 48 is greater in thickness than the flat parts 45E in the thickness direction of the flat parts 45E. Moreover, the plurality of wires 41 in the stacked bent part 48 bend in an overlapping state such that the stacked bent part 48 is narrower in width than the flat parts 45E in the width direction of the flat parts 45E. The wire harness 30E is provided with the first bend fixing tape member 70 and the second bend fixing tape member 80 that are affixed together with the stacked bent part 48 sandwiched therebetween. The first bend fixing tape member 70 and the second bend fixing tape member 80 maintain the arrangement and bent shape of the plurality of wires 41 in the stacked bent part 48.

According to this configuration, in the case where the routing location of the wire harness 30E has a bent part, the stacked bent part 48 can be formed into a shape that corresponds to the shape of the bent part. Furthermore, the stacked bent part 48 can be maintained in a bent shape by the first bend fixing tape member 70 and the second bend fixing tape member 80. Accordingly, routing of the wire harness 30E having the flat parts 45E can be performed more easily.

### Seventh Embodiment

Hereinafter, a seventh embodiment of a wire harness will be described. Note that, in this seventh embodiment, the same reference numerals are given to configuration that is the same as or corresponds to the above embodiments, and description thereof will be partially or wholly omitted.

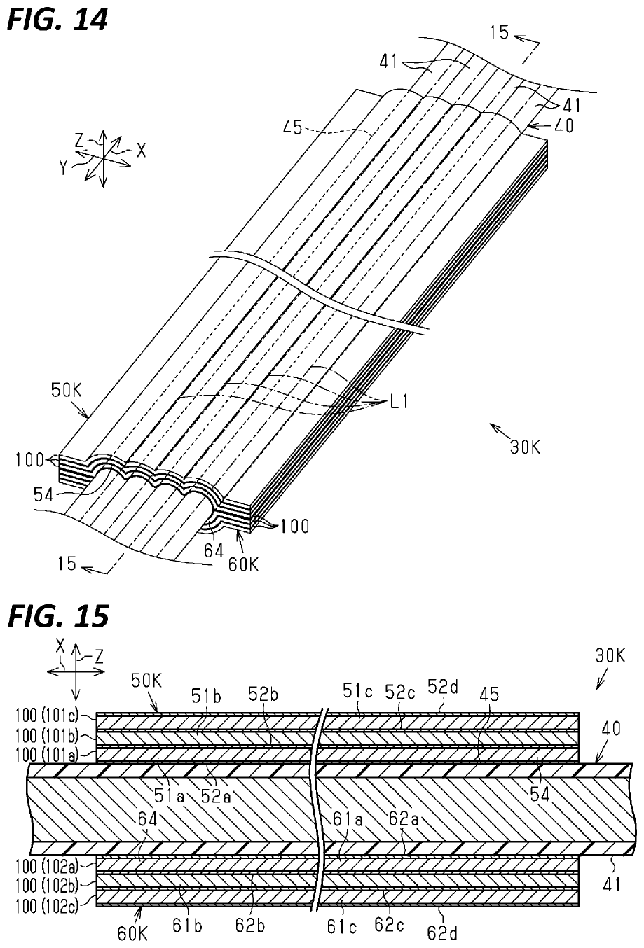

As shown in FIGS. 14 and 15, a wire harness 30K of this seventh embodiment is provided with a wire bundle 40 having a flat part 45, a first tape member 50K, and a second tape member 60K. Note that FIG. 15 is a sectional view taken along line 15-15 in FIG. 14.

The first tape member 50K and the second tape member 60K are affixed together with the flat part 45 sandwiched therebetween from both sides in the thickness direction of the flat part 45. Electrical wires 41 in the flat part 45 are integrally held by the first tape member 50K and the second tape member 60K.

The first tape member 50K is, for example, band shaped extending in the extension direction X as a whole. The first tape member 50K has a plurality of pieces of tape 100 that are overlaid on each other in the thickness direction of the flat part 45, that is, in the second direction Z. For example, the first tape member 50K has three pieces of first tape, namely, first tape 101a, 101b and 101c, as the plurality of pieces of tape 100. Note that the number of pieces of tape 100 included in the first tape member 50K is not limited to three, and may be two or four or more. Incidentally, the first tape member 50 in each of the first to sixth embodiments is constituted by one piece of tape 100.

The first tape 101a is directly adhered to the flat part 45. The first tape 101a may have circular-arc sticking portions 54. The first tape 101b is directly layered on the first tape 101a in the second direction Z. The first tape 101c is directly layered on the first tape 101b in the second direction Z. The widths of the first tape 101a, 101b and 101c in the first direction Y are, for example, equal to each other. The lengths of the first tape 101a, 101b and 101c in the extension direction X are, for example, equal to each other. Also, the positions of the first tape 101a, 101b and 101c in the extension direction X are, for example, the same as each other.

The second tape member 60K is, for example, band shaped extending in the extension direction X as a whole. The second tape member 60K has a plurality of pieces of tape 100 that are overlaid on each other in the second direction Z. For example, the second tape member 60K has three pieces of second tape, namely, second tape 102a, 102b and 102c, as the plurality of pieces of tape 100. Note that the number of pieces of tape 100 included in the second tape member 60K is not limited to three, and may be two or four or more. Also, the number of pieces of tape 100 included in the second tape member 60K may differ from the number of pieces of tape 100 included in the first tape member 50K. Incidentally, the second tape member 60 in each of the first to sixth embodiments is constituted by one piece of tape 100.

The second tape 102a is directly adhered to the flat part 45 such that the second tape 102a and the first tape 101a sandwich the flat part 45. The second tape 102a may have circular-arc sticking portions 64. The second tape 102b is directly layered on the second tape 102a in the second direction Z. The second tape 102c is directly layered on the second tape 102b in the second direction Z. The widths of the second tape 102a, 102b and 102c in the first direction Y are, for example, equal to each other. For example, the widths of the second tape 102a, 102b and 102c in the first direction Y are equal to the widths of the first tape 101a, 101b and 101c in the first direction Y. The lengths of the second tape 102a, 102b and 102c in the extension direction X are, for example, equal to each other. For example, the lengths of the second tape 102a, 102b and 102c in the extension direction X are equal to the lengths of the first tape 101a, 101b and 101c in the extension direction X. Also, the positions of the second tape 102a, 102b and 102c in the extension direction X are, for example, the same as each other. For example, the positions of the second tape 102a, 102b and 102c in the extension direction X are the same as the positions of the first tape 101a, 101b and 101c in the extension direction X.

The pieces of tape 100 are each band shaped extending in the extension direction X, for example. The first tape 101a has, for example, a first substrate 51a and a first adhesive layer 52a laminated on one surface of the first substrate 51a. The first tape 101b has, for example, a first substrate 51b and a first adhesive layer 52b laminated on one surface of the first substrate 51b. The first tape 101c has, for example, a first substrate 51c and a first adhesive layer 52c laminated on one surface of the first substrate 51c. The first substrates 51a, 51b and 51c are each, for example, band shaped.

The second tape 102a has, for example, a second substrate 61a and a second adhesive layer 62a laminated on one surface of the second substrate 61a. The second tape 102b has, for example, a second substrate 61b and a second adhesive layer 62b laminated on one surface of the second substrate 61b. The second tape 102c has, for example, a second substrate 61c and a second adhesive layer 62c laminated on one surface of the second substrate 61c. The second substrates 61a, 61b and 61c are each, for example, band shaped.

The first tape 101a and the second tape 102a are each, for example, metal tape. In the case where the first tape 101a and the second tape 102a are metal tape, the first substrate 51a and the second substrate 61a are each made of metal. For example, the first substrate 51a and the second substrate 61a are each band-shaped aluminum foil.

The first tape 101b and the second tape 102b are each, for example, protective tape similar to the first tape member 50 of the above first embodiment.

The first tape 101c and the second tape 102c are each, for example, double-sided tape. In the case where the first tape 101c is double-sided tape, the first tape 101c further has a first adhesive layer 52d on the opposite surface of the first substrate 51c to the surface on which the first adhesive layer 52c is laminated. In the case where the second tape 102c is double-sided tape, the second tape 102c further has a second adhesive layer 62d on the opposite surface of the second substrate 61c to the surface on which the second adhesive layer 62c is laminated. In the first tape 101c, the first adhesive layer 52c is adhered to the first tape 101b, while the first adhesive layer 52d is adherable to the routing location of the flat part 45. In the second tape 102c, the second adhesive layer 62c is adhered to the second tape 102b, while the second adhesive layer 62d is adherable to the routing location of the flat part 45.

According to this seventh embodiment, the following operation and effects are achieved, in addition to similar operation and effects to (1-1) to (1-5), (1-7) and (1-9) to (1-11) of the above first embodiment, and the operation and effect of the above second embodiment.

(7-1) The first tape member 50K and the second tape member 60K each have a plurality of pieces of tape 100 that are overlaid on each other in the second direction Z. According to this configuration, by adjusting the number of pieces of tape 100, the respective thicknesses of the first tape member 50K and the second tape member 60K in the second direction Z can be adjusted. Also, the first tape member 50K and the second tape member 60K can each be constituted by a plurality of types of tape 100.

(7-2) The first tape member 50K and the second tape member 60K each include protective tape having a substrate that is greater in thickness than the substrate included in wire bundling tape that is used for bundling wires and an adhesive layer laminated on one surface of the substrate. Also, the first tape member 50K and the second tape member 60K each include metal tape having a band-shaped metal substrate. Also, the first tape member 50K and the second tape member 60K each include double-sided tape having a band-shaped substrate and an adhesive layer laminated on both surfaces of the substrate.

According to this configuration, when the first tape member 50K and the second tape member 60K each include protective tape, the portion of the flat part 45 that is covered with the protective tape can be protected from peripheral members by the protective tape.

When the first tape member 50K and the second tape member 60K each include metal tape, external emission of electromagnetic noise from the wires 41 in the flat part 45 can be suppressed by the metal tape, in the portion of the flat part 45 to which the metal tape is adhered. Also, in this same portion, ingress of external electromagnetic noise into the wires 41 in the flat part 45 can be suppressed by the metal tape. Also, in this same portion, since the metal tape is able to reflect radiant heat, an increase in temperature of the wires 41 in the flat part 45 can be suppressed.

Also, when the first tape member 50K and the second tape member 60K each include double-sided tape, one of the two adhesive layers of the double-sided tape can be adhered to the flat part 45. Furthermore, the flat part 45 can be easily fixed, by adhering the other adhesive layer to the routing location of the flat part 45. In other words, a component for fixing the flat part 45 need not be separately prepared.

### Eighth Embodiment

Hereinafter, an eighth embodiment of a wire harness will be described. Note that, in this eighth embodiment, the same reference numerals are given to configuration that is the same as or corresponds to the above embodiments, and description thereof will be partially or wholly omitted.

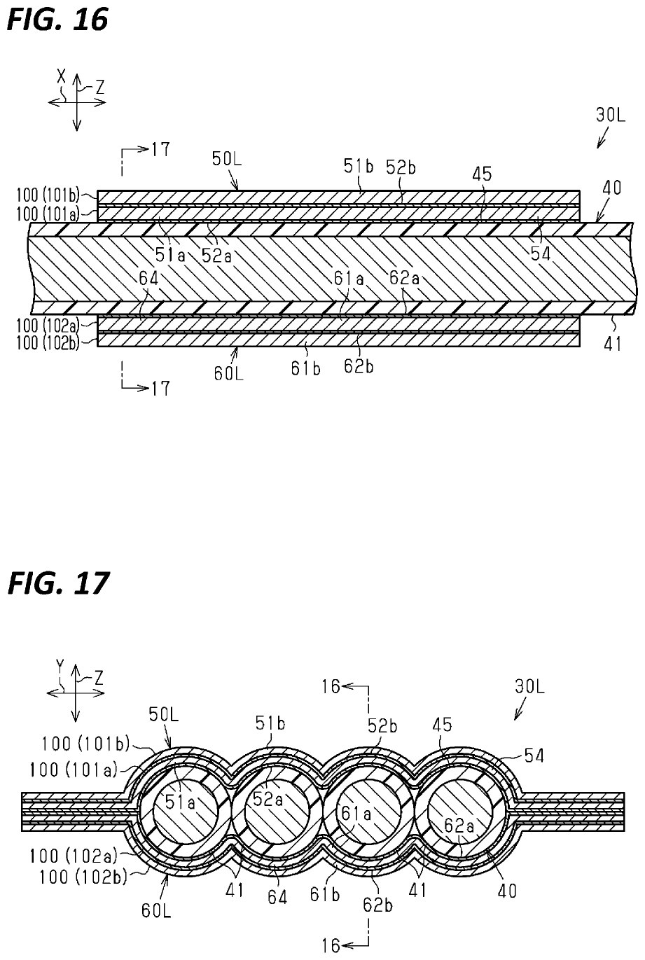

As shown in FIGS. 16 and 17, a wire harness 30L of this eighth embodiment is provided with a wire bundle 40 having a flat part 45, a first tape member 50L, and a second tape member 60L. Note that FIG. 16 is a longitudinal sectional view taken along line 16-16 in FIG. 17 and shows part of the wire harness 30L. FIG. 17 is a transverse sectional view taken along line 17-17 in FIG. 16 and shows part of the wire harness 30L.

The first tape member 50L and the second tape member 60L are affixed together with the flat part 45 sandwiched therebetween from both sides in the thickness direction of the flat part 45. Electrical wires 41 in the flat part 45 are integrally held by the first tape member 50L and the second tape member 60L.

The first tape member 50L and the second tape member 60L are each, for example, band shaped extending in the extension direction X as a whole. At least one of the first tape member 50L and the second tape member 60L may have a plurality of pieces of tape 100 of the same type that are overlaid on each other in the second direction Z. For example, the first tape member 50L and the second tape member 60L each have a plurality of pieces of tape 100 of the same type that are overlaid on each other in the second direction Z.

For example, the first tape member 50L has two pieces of first tape, namely, first tape 101a and 101b, as the plurality of pieces of tape 100. For example, the first tape 101a is metal tape similarly to the above seventh embodiment, and the first tape 101b is metal tape of the same type as the first tape 101a.

For example, the second tape member 60L has two pieces of second tape, namely, second tape 102a and 102b, as the plurality of pieces of tape 100. Note that the number of pieces of tape 100 included in each of the first tape member 50L and the second tape member 60L is not limited to three, and may be two or four or more. Also, the number of pieces of tape 100 included in the first tape member 50L may differ from the number of pieces of tape 100 included in the second tape member 60L. For example, the second tape 102a is metal tape similarly to the above seventh embodiment, and the second tape 102b is metal tape of the same type as the second tape 102a.

The pieces of first tape 101a and 101b and the pieces of second tape 102a and 102b are disposed relative to the flat part 45 in a similar mode to the above seventh embodiment.

According to this eighth embodiment, the following operation and effects are achieved, in addition to similar operation and effects to (1-1) to (1-5), (1-7) and (1-9) to (1-11) of the above first embodiment, and the operation and effect of the above second embodiment.

(8-1) The first tape member 50L and the second tape member 60L each have a plurality of pieces of tape 100 of the same type that are overlaid on each other in the second direction Z. According to this configuration, the thickness of each of the first tape member 50L and the second tape member 60L in the second direction Z can be easily increased by layering a plurality of pieces of tape 100 of the same type. In addition, the portion of the flat part 45 that is covered by the portion in which the plurality of pieces of tape 100 of the same type are overlaid on each other can be protected from peripheral members by the portion in which the plurality of pieces of tape 100 of the same type are overlaid on each other. Also, the plurality of pieces of tape 100 can be easily prepared, compared to the case where a plurality of types of tape 100 are overlaid on each other.

(8-2) The first tape member 50L and the second tape member 60L each include metal tape having a band-shaped metal substrate. According to this configuration, when the first tape member 50L and the second tape member 60L include metal tape, external emission of electromagnetic noise from the wires 41 in the flat part 45 is suppressed by the metal tape, in the portion of the flat part 45 to which the metal tape is adhered. Also, in this same portion, ingress of external electromagnetic noise into the wires 41 in the flat part 45 can be suppressed by the metal tape. Also, in this same portion, since the metal tape is able to reflect radiant heat, an increase in temperature of the wires 41 in the flat part 45 can be suppressed.

### Ninth Embodiment

Hereinafter, a ninth embodiment of a wire harness will be described. Note that, in this ninth embodiment, the same reference numerals are given to configuration that is the same as or corresponds to the above embodiments, and description thereof will be partially or wholly omitted.

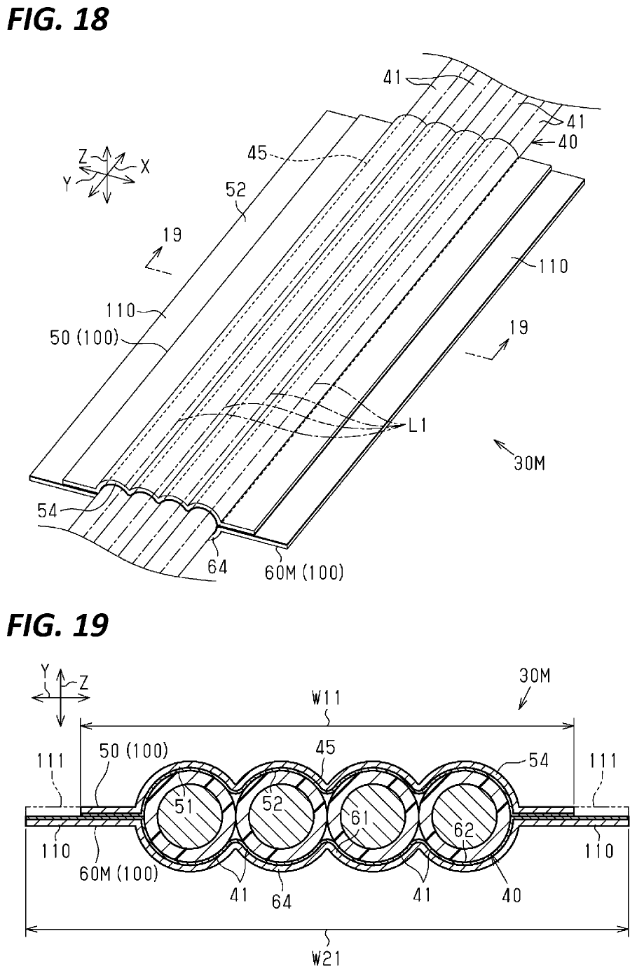

As shown in FIGS. 18 and 19, a wire harness 30M of this ninth embodiment is provided with a wire bundle 40 having a flat part 45, the first tape member 50 of the above second embodiment, and a second tape member 60M. Note that FIG. 19 is a sectional view taken along line 19-19 in FIG. 18.

The first tape member 50 and the second tape member 60M each have at least one piece of tape 100. For example, the first tape member 50 and the second tape member 60M each have one piece of tape 100.

The tape 100 constituting the first tape member 50 has a first width W11. The first width W11 is the length of the tape 100 in the first direction Y.

The second tape member 60M is protective tape similar to the second tape member 60 of the above second embodiment. That is, the tape 100 constituting the second tape member 60M is protective tape. The tape 100 constituting the second tape member 60M has a second width W21 that is greater than the first width W11. The second width W21 is the length of the tape 100 in the first direction Y.

The tape 100 having the first width W11, that is, the first tape member 50, and the tape 100 having the second width W21, that is, the second tape member 60M, are overlaid on the flat part 45 from both sides in the second direction Z. The width in the first direction Y is greater in the tape 100 having the second width W21 than in the tape 100 having the first width W11. Thus, the tape 100 having the second width W21 has a sticking portion 110 that does not overlap with the tape 100 having the first width W11 in the second direction Z, in at least one of the two edge regions in the first direction Y. For example, the tape 100 having the second width W21 has the sticking portion 110 in both edge region in the first direction Y. In the sticking portion 110, a second adhesive layer 62 is not covered by the tape 100 having the first width W11. Thus, the sticking portion 110 is adherable to the routing location of the flat part 45.

Note that, in the period until the flat part 45 is disposed in the routing location, such as during transportation of the wire harness 30M, release paper 111 may be adhered to the second adhesive layer 62 in the sticking portion 110. FIG. 19 illustrates the release paper 111 with a two-dotted line. In the case where the release paper 111 is not adhered to the second adhesive layer 62 in the sticking portion 110, the tape 100 having the second width W21 may be folded over, so as to overlay the sticking portion 110 on an edge region of the tape 100 having the first width W11 in the first direction Y. In this case, the second adhesive layer 62 in the sticking portion 110 is adhered to an opposite surface of the first substrate 51 to the surface on which the first adhesive layer 52 is layered. At the time of disposing the flat part 45 in the routing location, the sticking portion 110 is then adhered to the routing location after being peeled off from the tape 100 having the first width W11.

According to this ninth embodiment, the following operation and effect is achieved, in addition to similar operation and effects to the above first embodiment and the above second embodiment.

(9-1) The first tape member 50 and the second tape member 60M each have at least one piece of tape 100. The first tape member 50 has tape 100 having the first width W11. The second tape member 60M has tape 100 having a second width W21 that is greater than the first width W11. The tape 100 having the first width W11 and the tape 100 having the second width W21 are overlaid on the flat part 45 from both sides in the second direction Z.

According to this configuration, the tape 100 having the second width W21 protrudes in the width direction of the flat part 45 with respect to the tape 100 having the first width W11. The flat part 45 can thus be easily fixed, due to the portion of the tape 100 having the second width W21 that protrudes in the width direction of the flat part 45 with respect to the tape 100 having the first width W11 being adhered to the routing location of the flat part 45. In other words, a component for fixing the flat part 45 need not be separately prepared.

### Tenth Embodiment

Hereinafter, a tenth embodiment of a wire harness will be described. Note that, in this tenth embodiment, the same reference numerals are given to configuration that is the same as or corresponds to the above embodiments, and description thereof will be partially or wholly omitted.

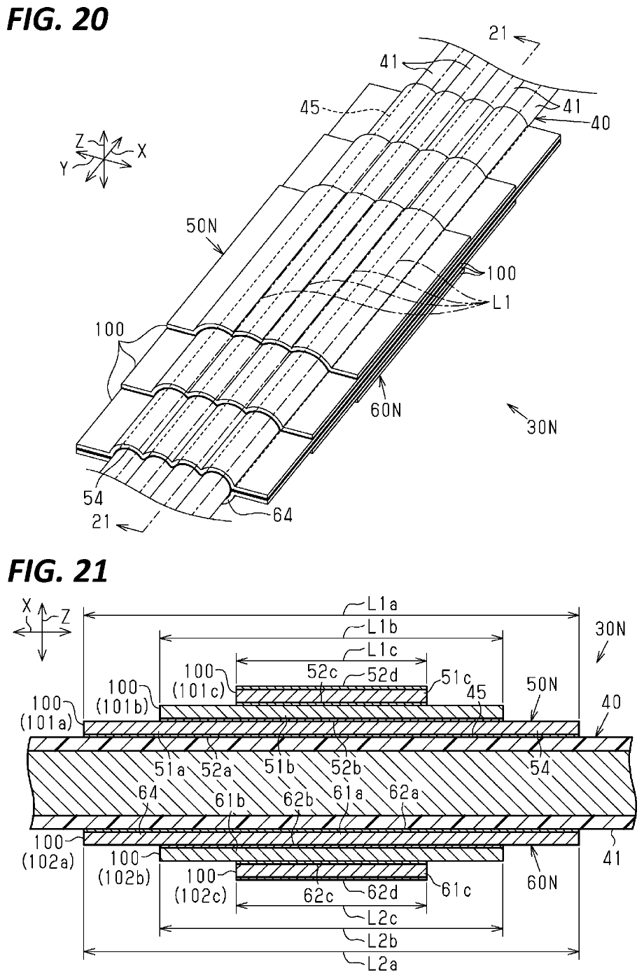

As shown in FIGS. 20 and 21, a wire harness 30N of this tenth embodiment is provided with a wire bundle 40 having a flat part 45, a first tape member 50N, and a second tape member 60N. Note that FIG. 21 is a sectional view taken along line 21-21 in FIG. 20.

The first tape member 50N and the second tape member 60N are affixed together with the flat part 45 sandwiched therebetween from both sides in the thickness direction of the flat part 45. Electrical wires 41 in the flat part 45 are integrally held by the first tape member 50N and the second tape member 60N.

The first tape member 50N is, for example, band shaped extending in the extension direction X as a whole. The first tape member 50N has a plurality of pieces of tape 100. For example, the first tape member 50N has three pieces of first tape, namely, first tape 101a, 101b and 101c, as the plurality of pieces of tape 100. Note that the number of pieces of tape 100 included in the first tape member 50N is not limited to three, and may be two or four or more.

The first tape 101a is directly adhered to the flat part 45. The first tape 101b is directly layered on the first tape 101a in the second direction Z. The first tape 101c is directly layered on the first tape 101b in the second direction Z. The first tape 101a, 101b and 101c are overlaid on each other such that, for example, the respective centers thereof in the extension direction X overlap each other in the second direction Z.

The widths of the first tape 101a, 101b and 101c in the first direction Y may be equal to each other. Also, the lengths of the first tape 101a, 101b and 101c in the extension direction X may differ from each other. For example, the first tape member 50N has the first tape 101b having a length L1b and the first tape 101a having a length L1a that is longer than the length L1b. In this case, the length L1b corresponds to the “first length” and the length L1a corresponds to the “second length.” Also, for example, the first tape member 50N has the first tape 101c having a length L1c and the first tape 101b having the length L1b which is longer than the length L1c. In this case, the length L1c corresponds to the “first length” and the length L1b corresponds to the “second length.” Also, for example, the first tape member 50N has the first tape 101c having the length L1c and the first tape 101a having the length L1a which is longer than the length L1c. In this case, the length L1c corresponds to the “first length” and the length L1a corresponds to the “second length.”

The second tape member 60N is, for example, band shaped extending in the extension direction X as a whole. The second tape member 60N has a plurality of pieces of tape 100. For example, the second tape member 60N has three pieces of second tape, namely, second tape 102a, 102b and 102c, as the plurality of pieces of tape 100. Note that the number of pieces of tape 100 included in the second tape member 60N is not limited to three, and may be two or four or more. Also, the number of pieces of tape 100 included in the second tape member 60N may differ from the number of pieces of tape 100 included in the first tape member 50N.

The second tape 102a is directly adhered to the flat part 45 such that the second tape 102a and the flat part 45 sandwich the first tape 101a. The position of the second tape 102a in the extension direction X is, for example, the same as the position of the first tape 101a in the extension direction X. The second tape 102b is directly layered on the second tape 102a in the second direction Z. The second tape 102c is directly layered on the second tape 102b in the second direction Z. The second tape 102a, 102b and 102c are overlaid on each other such that, for example, the respective centers thereof in the extension direction X overlap each other in the second direction Z.

The widths of the second tape 102a, 102b and 102c in the first direction Y may be equal to each other. Also, the lengths of the second tape 102a, 102b and 102c in the extension direction X may differ from each other. For example, a length L2a of the second tape 102a in the extension direction X is equal to the length L1a of the first tape 101a in the extension direction X. Also, for example, a length L2b of the second tape 102b in the extension direction X is equal to the length L1b of the first tape 101b in the extension direction X. Also, for example, a length L2c of the second tape 102c in the extension direction X is equal to the length L1c of the first tape 101c in the extension direction X. For example, the length L2b is thus shorter than the length L2a. Also, for example, the length L2c is shorter than the length L2b. Note that the length L1a and length L2a may be different lengths. Similarly, the length L1b and length L2b and the length L1c and length L2c may be different lengths.

The first tape 101a and second tape 102a, the first tape 101b and first tape 101b, and the first tape 101c and second tape 102c are, for example, respectively in the same positions in the extension direction X. Incidentally, the first tape 101a and second tape 102a, the first tape 101b and first tape 101b, and the first tape 101c and second tape 102c are, for example, respectively paired with each other.

The first tape 101a and the second tape 102a are each, for example, metal tape similarly to the above seventh embodiment. The first tape 101b and the second tape 102b are each, for example, protective tape similar to the above seventh embodiment. The first tape 101c and the second tape 102c are each, for example, double-sided tape similarly to the above seventh embodiment.

The flat part 45 is fixed to the routing location of the flat part 45, due to at least one of a first adhesive layer 52d of the first tape 101c and a second adhesive layer 62d of the second tape 102c being adhered to the routing location.

According to this tenth embodiment, the following operation and effects are achieved, in addition to similar operation and effects to (1-1) to (1-5), (1-7) and (1-9) to (1-11) of the above first embodiment, the operation and effect of the above second embodiment, and the operation and effects of the above seventh embodiment.

(10-1) The first tape member 50N has the first tape 101c and the first tape 101a and 101b that are longer than the first tape 101c in the extension direction X. The first tape 101a is longer than the first tape 101b in the extension direction X. Also, the second tape member 60N has the second tape 102c and the second tape 102a and 102b that are longer than the second tape 102c in the extension direction X. The second tape 102a is longer than the second tape 102b in the extension direction X.

According to this configuration, in the first tape member 50N, the portion in which the first tape 101b and 101c are overlaid on the first tape 101a is thicker in the second direction Z, compared with the portion in which the first tape 101b and 101c are not overlaid. In the first tape member 50N, the portion in which the first tape 101a, the first tape 101b and the first tape 101c overlap each other in the second direction Z is the thickest portion in the second direction Z. Accordingly, due to the portion in which the first tape 101a and at least one of the first tape 101b and 101c overlap each other being disposed in the portion of the first tape member 50N where it is desired to increase the thickness in the second direction Z, the thickness can be easily partially increased. For example, due to the portion in which the first tape 101a, 101b and 101c overlap each other being disposed on a portion of the flat part 45 where it is desired to strengthen protection, protection of this portion from peripheral members can be easily strengthened. Also, the first tape member 50N can be partially provided, in the extension direction X, with the functions of the first tape 101b and 101c. Furthermore, the first tape member 50N can be fully provided, in the extension direction X, with the function of the first tape 101a. Similar operation and effects are also achieved with the second tape member 60N.

### Eleventh Embodiment

Hereinafter, an eleventh embodiment of a wire harness will be described. Note that, in an eleventh embodiment, the same reference numerals are given to configuration that is the same as or corresponds to the above embodiments, and description thereof will be partially or wholly omitted.

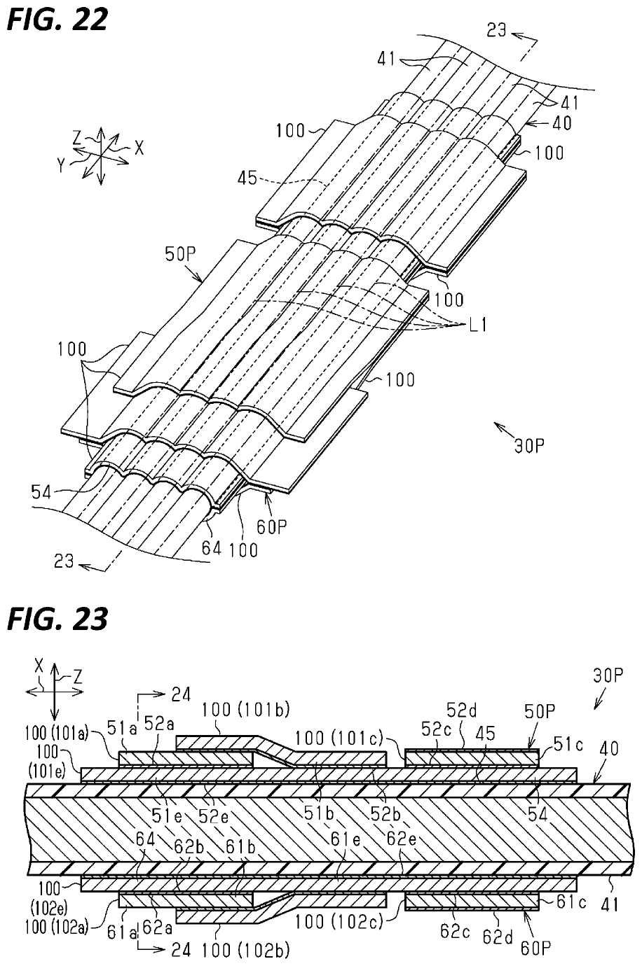

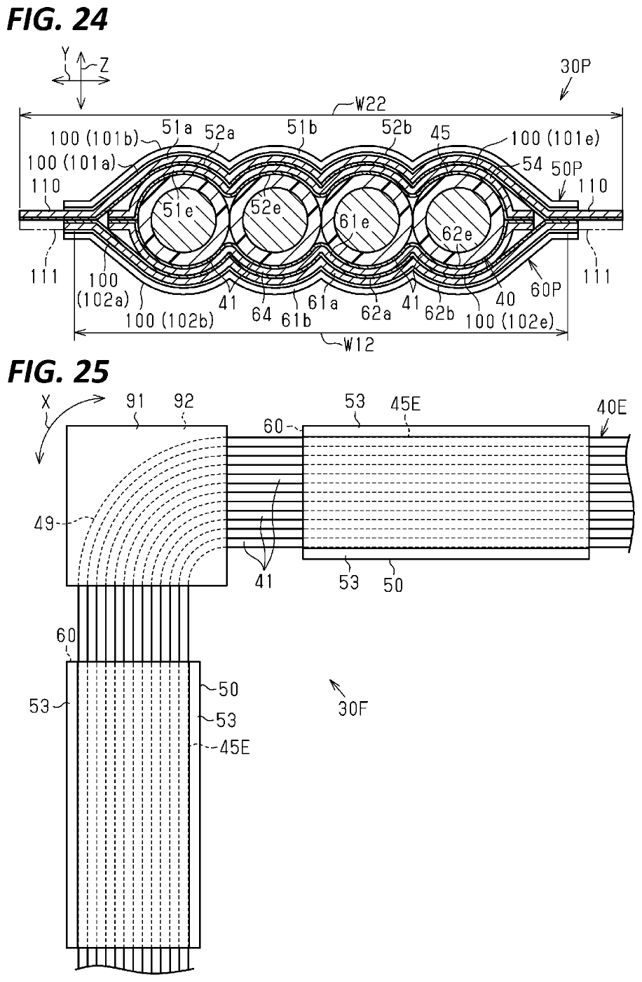

As shown in FIGS. 22, 23 and 24, a wire harness 30P of this eleventh embodiment is provided with a wire bundle 40 having a flat part 45, a first tape member 50P, and a second tape member 60P. Note that FIG. 23 is a sectional view taken along line 23-23 in FIG. 22. FIG. 24 is a sectional view taken along line 24-24 in FIG. 23.

The first tape member 50P and the second tape member 60P are affixed together with the flat part 45 sandwiched therebetween from both sides in the thickness direction of the flat part 45. Electrical wires 41 in the flat part 45 are integrally held by the first tape member 50P and the second tape member 60P.

The first tape member 50P is, for example, band shaped extending in the extension direction X as a whole. The first tape member 50P has a plurality of pieces of tape 100. For example, the first tape member 50P has four pieces of first tape, namely, first tape 101e, 101a, 101b and 101c, as the plurality of pieces of tape 100. Note that the number of pieces of tape 100 included in the first tape member 50P is not limited to four, but may be two, three, or five or more.

The second tape member 60P is, for example, band shaped extending in the extension direction X as a whole. The second tape member 60P has a plurality of pieces of tape 100. For example, the second tape member 60P has four pieces of second tape, namely, second tape 102e, 102a, 102b and 102c, as the plurality of pieces of tape 100. Note that the number of pieces of tape 100 included in the second tape member 60P is not limited to four, and need only be the same as the number of pieces of tape 100 included in the first tape member 50P.

The plurality of pieces of first tape 101e, 101a, 101b and 101c included in the first tape member 50P are paired one-to-one with the plurality of pieces of second tape 102e, 102a, 102b and 102c included in the second tape member 60P. That is, the first tape 101e and second tape 102e, the first tape 101a and second tape 102a, the first tape 101b and first tape 101b, and the first tape 101c and second tape 102c are respectively paired with each other. In this way, the first tape member 50P and the second tape member 60P have, for example, four pairs of tape 100.

The lengths of the pieces of tape 100 in each pair in the extension direction X are equal to each other. Also, the lengths of the paired pieces of tape 100 in the extension direction X are set individually for each pair. For example, the lengths of the paired first tape 101e and second tape 102e in the extension direction X are equal to each other. Also, for example, the lengths of the first tape 101a, 101b and 101c in the extension direction X are each shorter than the first tape 101e.

The paired first tape 101e and second tape 102e are overlaid on each other with the flat part 45 sandwiched therebetween from both sides in the second direction Z, and the positions thereof in the extension direction X are the same as each other. The paired first tape 101a and second tape 102a are overlaid on each other with the flat part 45 sandwiched therebetween from both sides in the second direction Z, and the positions thereof in the extension direction X are the same as each other. The paired first tape 101b and second tape 102b are overlaid on each other with the flat part 45 sandwiched therebetween from both sides in the second direction Z, and the positions thereof in the extension direction X are the same as each other. The paired first tape 101c and second tape 102c are overlaid on each other with the flat part 45 sandwiched therebetween from both sides in the second direction Z, and the positions thereof in the extension direction X are the same as each other.

The plurality of pieces of tape 100 included in the first tape member 50P each at least partially overlap at least one of the plurality of pieces of tape 100 included in the first tape member 50P in the second direction Z. For example, the first tape 101e is directly adhered to the flat part 45. The first tape 101a is directly layered on the first tape 101e in the second direction Z. For example, the first tape 101a overlaps the first tape 101e throughout its entirety in the extension direction X. For example, one of the two end portions of the first tape 101b in the extension direction X is directly layered on the first tape 101a and the other end is directly layered on the first tape 101e. In addition, the first tape 101b overlaps the first tape 101e in the second direction Z throughout its entirety in the extension direction X, and a partial region thereof in the extension direction X overlaps the first tape 101a in the second direction Z. The first tape 101c is disposed in a position shifted in the extension direction X with respect to the first tape 101a and the first tape 101b, for example. That is, the first tape 101c may be layered on the first tape 101e in the second direction Z at a position that does not overlap with either the first tape 101a or 101b in the second direction Z. In addition, the first tape 101c is, for example, directly layered on the first tape 101e in the second direction Z throughout its entirety in the extension direction X.

The plurality of pieces of tape 100 included in the second tape member 60P each at least partially overlap at least one of the plurality of pieces of tape 100 included in the second tape member 60P in the second direction Z. Specifically, the second tape 102e is directly adhered to the flat part 45 similarly to the first tape 101e paired therewith, on the opposite side of the flat part 45 to the first tape 101e. Also, the second tape 102a is layered on the flat part 45 similarly to the first tape 101a paired therewith, on the opposite side to the first tape member 50P. Also, the second tape 102b is layered on the flat part 45 similarly to the first tape 101b paired therewith, on the opposite side to the first tape member 50P. Also, the second tape 102c is layered on the flat part 45 similarly to the first tape 101b paired therewith, on the opposite side to the first tape member 50P.

The first tape 101e has, for example, a band-shaped first substrate 51e and a first adhesive layer 52e laminated on one surface of the first substrate 51e. The second tape 102e has, for example, a band-shaped second substrate 61e and a second adhesive layer 62e laminated on one surface of the second substrate 61e. The first tape 101e and the second tape 102e are each, for example, wire bundling tape that is generally used to bind wires. The wire bundling tape is, for example, polyvinyl chloride (PVC) tape.

The first tape 101a and the second tape 102a are each, for example, metal tape similarly to the above seventh embodiment. The first tape 101b and the second tape 102b are each, for example, protective tape similar to the above seventh embodiment. The first tape 101c and the second tape 102c are each, for example, double-sided tape similarly to the above seventh embodiment.

The pieces of tape 100 forming at least one of the plurality of pairs of tape 100 differ from each other in width. The width is the length of the tape 100 in the first direction Y. For example, out of the four pairs of tape 100, the paired first tape 101a and second tape 102a differ from each other in width. For example, the first tape 101a is wider than the second tape 102a. Specifically, the second tape 102a has a first width W12. The first tape 101a has a second width W22 that is greater than the first width W12. The first tape 101a has a sticking portion 110 that does not overlap the second tape 102a in the second direction Z, in at least one of the two edge regions in the first direction Y. For example, the first tape 101a has the sticking portion 110 in both edge regions in the first direction Y.

Part of the flat part 45 is, for example, fixed to the routing location of the flat part 45, due to at least one of a first adhesive layer 52d of the first tape 101c and the second adhesive layer 62d of the second tape 102c being adhered to the routing location. Also, part of the flat part 45 is fixed to the routing location of the flat part 45, due to the sticking portion 110 being adhered to the routing location. Note that a configuration may be adopted in which, in the period until the flat part 45 is disposed in the routing location, a first adhesive layer 52a in the sticking portion 110 is prevented from adhering to other peripheral members, in a similar manner to the above ninth embodiment.

According to this eleventh embodiment, the following operation and effects are achieved, in addition to similar operation and effects to (1-1) to (1-5), (1-7) and (1-9) to (1-11) of the above first embodiment, and the operation and effects of the above second embodiment, seventh embodiment, ninth embodiment and tenth embodiment.

(11-1) The first tape member 50P and the second tape member 60P each include wire binding tape used for binding wires that has a band-shaped substrate and an adhesive layer laminated on one surface of the substrate. According to this configuration, since wire bundling tape is readily available, when the first tape member 50P and the second tape member 60P each include wire bundling tape, the first tape member 50P and the second tape member 60P are easily prepared.

(11-2) The first tape 101e and the second tape 102e are wire bundling tape. The wire bundling tape is polyvinyl chloride tape. According to this configuration, the wire bundling tape that is used as a material of each of the first tape member 50P and the second tape member 60P can be more readily obtained.

(11-3) The plurality of pieces of tape 100 included in the first tape member 50P are paired one-to-one with the plurality of pieces of tape 100 included in the second tape member 60P. The paired pieces of tape 100 are overlaid on each other with the flat part 45 sandwiched therebetween from both sides in the second direction Z, and the positions thereof in the extension direction X are the same as each other. The pieces of tape 100 forming one of the plurality of pairs of tape 100, that is, the paired first tape 101a and second tape 102a, differ from each other in width. The plurality of pieces of tape 100 included in the first tape member 50P each at least partially overlap at least one of the plurality of pieces of tape 100 included in the first tape member 50P in the second direction Z. The plurality of pieces of tape 100 included in the second tape member 60P each at least partially overlap at least one of the plurality of pieces of tape 100 included in the second tape member 60P in the second direction Z.

According to this configuration, when the paired pieces of tape 100 having different widths are overlaid on each other, the wider tape 100 protrudes in the width direction of the flat part 45 with respect to the narrower tape 100. That is, when the paired first tape 101a and second tape 102a are overlaid on each other, the first tape 101a protrudes in the first direction Y with respect to the second tape 102a. The flat part 45 can thus be easily fixed, due to the portion of the wider first tape 101a that protrudes in the first direction Y with respect to the narrower second tape 102a being adhered to the routing location of the flat part 45. In other words, a component for fixing the flat part 45 need not be separately prepared.

Also, in each of the first tape member 50P and the second tape member 60P, the plurality of pieces of tape 100 need only each be disposed so as to overlap a different piece of tape 100 in the second direction Z. Thus, the plurality of pieces of tape 100 can each be easily disposed in a desired position in the extension direction X, according to the functions of the respective pieces of tape 100. Also, by disposing the portion in which a plurality of pieces of tape 100 overlap so as to overlap a portion of the flat part 45 where it is desired to strengthen protection, protection of this portion from peripheral members can be strengthened.

### <Modifications>

The above embodiments can be carried out in a modified manner as follows. The above embodiments and the following modifications can be carried out in combination with each other to the extent that there are no technical inconsistencies.

A wire harness 30F shown in FIG. 25 is the wire harness 30E of the above sixth embodiment provided with a single-layer bent part 49 instead of the stacked bent part 48. Specifically, the wire bundle 40E has the single-layer bent part 49 in which the plurality of wires 41 bend while lined up flat in a position shifted in the extension direction X from the flat parts 45E. The single-layer bent part 49 has a similar configuration to the flat bent portion 47 of the above fifth embodiment. That is, the plurality of wires 41 in the single-layer bent part 49 are lined up in a row in a direction orthogonal to the thickness direction of the single-layer bent part 49, and bend while maintaining the arrangement of being lined up in a row, as seen in the thickness direction of the single-layer bent part 49.

The wire harness 30F is provided with a third tape member 91 and a fourth tape member 92 that are affixed together with the single-layer bent part 49 sandwiched therebetween from both sides in the thickness direction of the single-layer bent part 49. The third tape member 91 and the fourth tape member 92 maintain the arrangement and bent shape of the plurality of wires 41 in the single-layer bent part 49. The third tape member 91 and the fourth tape member 92 have a similar configuration to the first tape member 50 and the second tape member 60.

Adopting this configuration enables the single-layer bent part 49 in which the plurality of wires 41 bend at a position spaced apart from the flat parts 45E in the wire bundle 40E to also be easily maintained in a flat state by the third tape member 91 and the fourth tape member 92. Also, the single-layer bent part 49 can be easily maintained in a bent state by the third tape member 91 and the fourth tape member 92. Accordingly, the wire harness 30F can be easily disposed in narrow locations with the wire bundle 40E in a bent state.

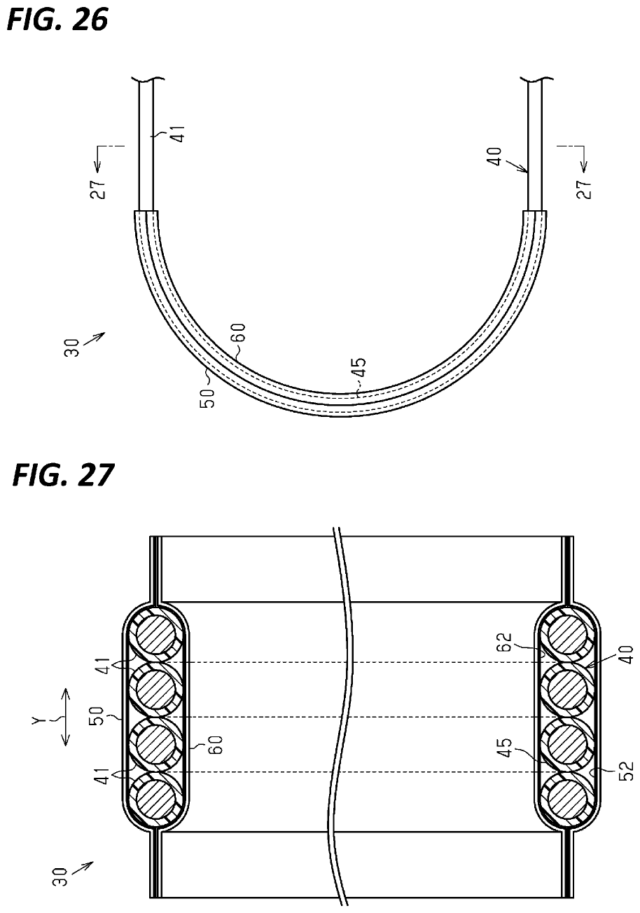

As shown in FIGS. 26 and 27, in the above first embodiment, the flat part 45 may be maintained in a curved shape by the first tape member 50 and the second tape member 60 as seen in the width direction of the flat part 45. Note that FIG. 27 is a sectional view taken along line 27-27 in FIG. 26. For example, the first tape member 50 and the second tape member 60 maintain the flat part 45 in a curved shape, by the adhesive force of the first adhesive layer 52 and the second adhesive layer 62, and also with the first substrate 51 and the second substrate 61. Adopting this configuration enables the flat part 45 to be easily disposed, in the case where the routing location of the flat part 45 is curved. The configurations of the above second to eleventh embodiments may also be similarly modified.

In the above tenth embodiment, the first tape 101b and 101c may each be disposed such that the center thereof in the extension direction X is shifted in the extension direction X with respect to the center of the first tape 101a in the extension direction X. The second tape 102b and 102c may also be similarly modified.

In the above ninth embodiment, the tape 100 having the second width W21 may be overlaid on the tape 100 having the first width W11, so as to only have the sticking portion 110 in one of the two edge regions in the first direction Y. The configuration of the above eleventh embodiment may also be similarly modified.

In the above seventh embodiment, the positions of the first tape 101a, 101b and 101c in the extension direction X need not be the same as each other. The first tape 101a, 101b and 101c each, however, at least partially overlap a first tape other than itself in the second direction Z. The second tape 102a, 102b and 102c may also be similarly modified.

In the above seventh embodiment, the widths of the first tape 101a, 101b and 101c in the first direction Y may differ from each other. For example, the widths of the first tape 101b and the first tape 101c in the first direction Y may be equal, and the width of the first tape 101a in the first direction Y may be greater than that of the first tape 101b and 101c. Also, the first tape 101a, 101b and 101c may all have different widths from each other. The second tape 102a, 102b and 102c may also be similarly modified. The configurations of the above eighth embodiment and the above tenth embodiment may also be similarly modified.

In the above first embodiment, the first tape member 50 and the second tape member 60 may be different types of tape member. Adopting this configuration enables the first tape member 50 and the second tape member 60 to each be selected, according to the environment of the location in which the flat part 45 is routed. The configurations of the above second to sixth embodiments may also be similarly modified.

In the above seventh embodiment, at least one of the first tape member 50K and the second tape member 60K may include at least one of wire binding tape, protective tape, sound absorbing tape, heat-resistant tape, metal tape, double-sided tape, a hook-and-loop fastener, and magnetic tape.

The wire bundling tape is tape generally used for bundling wires and has a band-shaped substrate and an adhesive layer laminated on one surface of the substrate. Since wire bundling tape is readily available, when at least one of the first tape member 50K and the second tape member 60K includes wire bundling tape, the at least one of the first tape member 50K and the second tape member 60K is easily prepared.

Sound absorbing tape is tape having a band-shaped porous substrate. For example, in the case where the first tape 101c is sound absorbing tape, the first substrate 51c is, for example, any of a band-shaped sponge, a band-shaped nonwoven fabric, a band-shaped woven fabric, or the like. When at least one of the first tape member 50K and the second tape member 60K includes sound absorbing tape, occurrence of abnormal noise can be suppressed, in the case where the portion of the flat part 45 to which the sound absorbing tape is adhered knocks or rubs against peripheral members.

Heat-resistant tape is tape that has superior heat resistance to wire bundling tape that is generally used for bundling wires. An example of heat-resistant tape is polyethylene terephthalate (PET) tape. When at least one of the first tape member 50K and the second tape member 60K includes heat-resistant tape, the heat resistance of the flat part 45 can be improved. Accordingly, the flat part 45 can also be disposed in a location that reaches a temperature within the heat resistant temperature range of the heat-resistant tape.

A band-shaped hook-and-loop fastener can be used as the hook-and-loop fastener. For example, in the case where the first tape 101c is a hook-and-loop fastener, the first substrate 51c has a hook structure (not shown) raised in a hook shape on the surface of the first substrate 51c that is on the opposite side to the first adhesive layer 52c. Note that the first substrate 51c may have a loop structure (not shown) raised in a loop shape, instead of the hook structure, on the surface of the first substrate 51c that is on the opposite side to the first adhesive layer 52c. Also, the first substrate 51c may have both a hook structure and a loop structure on the surface of the first substrate 51c that is on the opposite side to the first adhesive layer 52c. The first substrate 51c is disposed with respect to the flat part 45 such that the surface having the first adhesive layer 52c faces the flat part 45, and the surface of the first substrate 51c that is on the opposite side to the first adhesive layer 52c faces away from the flat part 45. When at least one of the first tape member 50K and the second tape member 60K includes a hook-and-loop fastener, the flat part 45 can be easily fixed utilizing the hook-and-loop fastener, in the case where the routing location of the flat part 45 has a surface to which the hook-and-loop fastener is attachable.

Magnetic tape is tape having a substrate that is a band-shaped magnet. For example, in the case where the first tape 101c is magnetic tape, the first substrate 51c is a band-shaped magnet. When at least one of the first tape member 50K and the second tape member 60K includes magnetic tape, the flat part 45 can be easily fixed by magnetic force utilizing the magnetic tape, in the case where the routing location of the flat part 45 has a portion made of a material that is attracted to a magnet.

The configurations of the above first to sixth embodiments and the above eighth to eleventh embodiments may be similarly modified.

In the above first embodiment, one of the first adhesive layer 52 and the second adhesive layer 62 may be omitted from the first tape member 50 and the second tape member 60 that are affixed to each other. For example, in the case where the first tape member 50 has the first adhesive layer 52, the second tape member 60 need not have the second adhesive layer 62. The configurations of the above second to sixth embodiments and the above ninth embodiment may be similarly modified. Also, in the above seventh embodiment, the above eighth embodiment and the above tenth embodiment, the first tape 101a and the second tape 102a may be similarly modified. Also, in the above eleventh embodiment, the first tape 101e and the second tape 102e may be similarly modified.

The number of wires 41 included in each of the wire bundles 40, 40C and 40E is not limited to the numbers given in the respective embodiments, and need only be two or more.

In the first embodiment, the configurations of the wire bundle 40 and the flat part 45 in which the plurality of wires 41 are lined up flat are not limited to the configurations of the above embodiment. This similarly applies to the above second to eleventh embodiments.

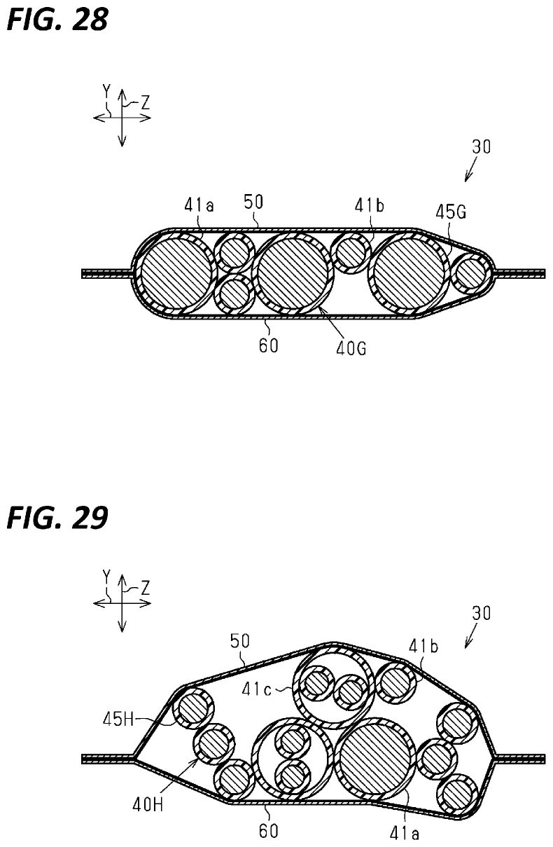

For example, instead of the wire bundle 40 of the above first embodiment, the wire harness 30 may be provided with a wire bundle 40G shown in FIG. 28. The wire bundle 40G has two types of wires 41a and 41b having different diameters. The wire bundle 40G has three wires 41a and four wires 41b that have a smaller diameter than the wires 41a. In a flat part 45G of the wire bundle 40G, the wires 41a and 41b are arranged in a flat manner in the first direction Y that perpendicularly intersects the extension direction X. The wires 41a and 41b in the flat part 45G are arranged such that the thickness of the flat part 45G in the second direction Z that perpendicularly intersects the first direction Y is smaller than the width of the flat part 45G in the first direction Y. In the flat part 45G, the wires 41a are lined up in a row in the first direction Y. Also, in the flat part 45G, two of the four wires 41b are lined up in a row in the second direction Z between two of the wires 41a. That is, these two wires 41b are stacked in the second direction Z between two wires 41a. Also, in the flat part 45G, the remaining two wires 41b are lined up in a row in the first direction Y together with the wires 41a.

Also, for example, instead of the wire bundle 40 of the above first embodiment, the wire harness 30 may be provided with a wire bundle 40H shown in FIG. 29. The wire bundle 40G has three types of wires 41a, 41b and 41c. The wires 41a and 41c have a larger diameter compared with the wires 41b. The diameters of the wire 41a and the wires 41c are, for example, equal. The wire bundle 40G has, for example, one wire 41a, seven wires 41b, and two wires 41c. In a flat part 45H included in the wire bundle 40G, a total of three wires 41a and 41b are arranged in a pile so as to be stacked in the second direction Z. In the flat part 45H, the three wires 41a and 41c are stacked in two layers in the second direction Z. Also, in the flat part 45H, six of the seven wires 41b are stacked in the second direction Z, with three on both sides of the wires 41a and 41c in the first direction Y. The three wires 41b that are stacked have a thickness in the second direction Z that is smaller than the stacked wires 41a and 41c. Also, in the flat part 45H, the remaining one wire 41b out of the seven wires 41b is disposed within the thickness range of the stacked wires 41a and 41c.

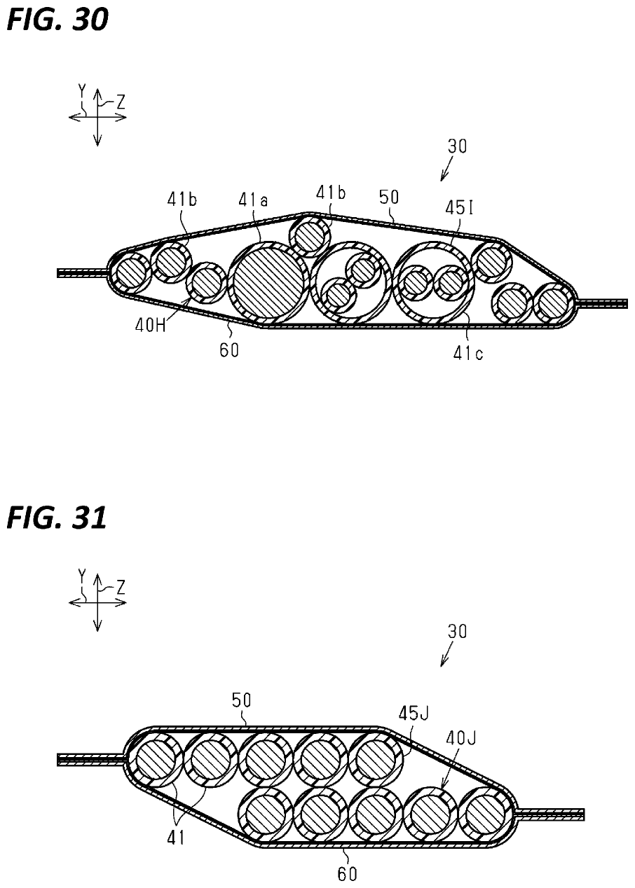

Also, for example, the wire bundle 40H may have a flat part 45I shown in FIG. 30. In the flat part 45I, the wires 41a and 41c are lined up in a row in the first direction Y. Also, in the flat part 45I, five of the seven wires 41b are lined up in a row in the first direction Y together with the wires 41a and 41c. Also, in the flat part 45I, the remaining two wires 41b out of the seven wires 41b are stacked on the wires 41a and 41c or the wire 41a in the second direction Z.

Also, for example, instead of the wire bundle 40 of the above first embodiment, the wire harness 30 may be provided with a wire bundle 40J shown in FIG. 31. The wire bundle 40J has ten wires 41. In a flat part 45J included in the wire bundle 40J, the ten wires 41 are lined up five to a row in the first direction Y. In the flat part 45J, there are thus two rows of wires 41 lined up in the first direction Y. In addition, in the flat part 45J, the layers of wires 41 lined up in the first direction Y are stacked in two layers in the second direction Z.

In the above first embodiment, the entire wire bundle 40 may be the flat part 45. Also, in the above first embodiment, the wire bundle 40 may have a plurality of flat parts 45. In this case, the wire harness 30 has a plurality of sets of the first tape member 50 and the second tape member 60, according to the number of flat parts 45. The configurations of the above second to eleventh embodiments may also be similarly modified.

### LIST OF REFERENCE NUMERALS

30, 30A, 30B, 30C, 30D, 30E, 30F, 30K, 30L, 30M, 30N, 30P Wire harness
40, 40C, 40D, 40E, 40G, 40H, 40J Wire bundle
41, 41a, 41b, 41c Electrical wire
42 Core wire
43 Insulation coating
45, 45a, 45b, 45B, 45D, 45E, 45G, 45H, 45I, 45J Flat part
46 Stacked part
47 Flat bent portion
48 Overlapping bent part
49 Single-layer bent part
50, 50K, 50L, 50N, 50P First tape member
51, 51a, 51b, 51c, 51e First substrate (substrate)
52, 52a, 52b, 52c, 52d, 52e First adhesive layer (adhesive layer)
53 First sticking edge portion
54 First circular-arc sticking portion (circular-arc sticking portion)
55 First inter-wire sticking portion
60, 60K, 60L, 60M, 60N, 60P Second tape member
61, 61a, 61b, 61c, 61e Second substrate (substrate)
62, 62a, 62b, 62c, 62d, 62e Second adhesive layer (adhesive layer)
63 Second sticking edge portion
64 Second circular-arc sticking portion (circular-arc sticking portion)
65 Second inter-wire sticking portion
70 First bend fixing tape member
71 First substrate
72 First adhesive layer
80 Second bending tape member
81 Second substrate
82 Second adhesive layer
91 Third tape member
92 Fourth tape member
100 Tape
101a, 101b, 101c, 101e First tape
102a, 102b, 102c, 102e Second tape
L1a, L2a Length (second length)
L1b, L2b Length (first length, second length)
L1c, L2c Length (first length)
110 Sticking portion
111 Release paper
W11, W12 First width
W12, W22 Second width
X Extension direction (direction in which wire bundle extends)
Y First direction
Z Second direction

1. A wire harness comprising:
a wire bundle having a plurality of electrical wires and a flat part in which the plurality of wires are lined up flat in at least part thereof in a direction in which the wire bundle extends; and
a first tape member and a second tape member affixed together with the flat part sandwiched therebetween from both sides in a thickness direction of the flat part.

2. The wire harness according to claim 1,
wherein the first tape member and the second tape member are each band shaped and extend in the direction in which the wire bundle extends.

3. The wire harness according to claim 1,
wherein the first tape member and the second tape member are directly affixed to each other on both sides in a width direction of the flat part.

4. The wire harness according to claim 1,
wherein at least one of the first tape member and the second tape member is adhered to at least part of an outer peripheral surface of at least one of the wires located between the first tape member and the second tape member.

5. The wire harness according to claim 1,
wherein at least one of the first tape member and the second tape member has a circular-arc sticking portion that is circular arc shaped around an outer peripheral surface of at least one of the wires located between the first tape member and the second tape member and adhered to the outer peripheral surface.

6. The wire harness according to claim 1,
wherein the first tape member and the second tape member are directly affixed to each other between the wires adjacent in the flat part.

7. The wire harness according to claim 1,
wherein the first tape member and the second tape member each have a plurality of pieces of tape overlaid on each other in the thickness direction of the flat part.

8. The wire harness according to claim 1,
wherein at least one of the first tape member and the second tape member includes at least one of:
wire bundling tape for use in bundling wires and having a band-shaped substrate and an adhesive layer laminated on one surface of the substrate thereof;
protective tape having a substrate greater in thickness than the substrate included in the wire bundling tape, and an adhesive layer laminated on one surface of the substrate thereof;
sound absorbing tape having a band-shaped porous substrate;
heat-resistant tape having superior heat resistance to the wire bundling tape;
metal tape having a band-shaped metal substrate;
double-sided tape having a band-shaped substrate and an adhesive layer laminated on both surfaces of the substrate thereof;
a band-shaped hook-and-loop fastener; and
magnetic tape having a substrate that is a band-shaped magnet.

9. The wire harness according to claim 8,
wherein the wire bundling tape is polyvinyl chloride tape.

10. The wire harness according to claim 8,
wherein the protective tape is polypropylene tape.

11. The wire harness according to claim 7,
wherein the plurality of pieces of tape of at least one of the first tape member and the second tape member are pieces of tape of the same type overlaid on each other in the thickness direction of the flat part.

12. The wire harness according to claim 1,
wherein the first tape member and the second tape member each have at least one piece of tape,
the tape of one of the first tape member and the second tape member has a first width, and the tape of the other of the first tape member and the second tape member has a second width greater than the first width, and
the tape having the first width and the tape having the second width are overlaid on the flat part from both sides in the thickness direction of the flat part.

13. The wire harness according to claim 7,
wherein the plurality of pieces of tape of at least one of the first tape member and the second tape member include tape having a first length and tape having a second length longer than the first length, and the tape having the first length and the tape having the second length have a portion in which the pieces of tape are overlaid on each other in the thickness direction of the flat part.

14. The wire harness according to claim 7,
wherein the plurality of pieces of tape included in the first tape member are paired one-to-one with the plurality of pieces of tape included in the second tape member,
the paired pieces of tape are overlaid on each other with the flat part sandwiched therebetween from both sides in the thickness direction of the flat part, and positions thereof in the direction in which the wire bundle extends are the same as each other,
the pieces of tape forming at least one of the plurality of pairs of tape differ from each other in width,
the plurality of pieces of tape included in the first tape member each at least partially overlap at least one of the plurality of pieces of tape included in the first tape member in the thickness direction of the flat part, and
the plurality of pieces of tape included in the second tape member each at least partially overlap at least one of the plurality of pieces of tape included in the second tape member in the thickness direction of the flat part.

15. The wire harness according to claim 1,
wherein the wire bundle has two of the flat part spaced apart from each other in the direction in which the wire bundle extends, and a stacked part located between the two flat parts in the direction in which the wire bundle extends and in which the wires are arranged differently to the wires in the flat parts,
the two flat parts and the stacked part are sandwiched between the first tape member and the second tape member, and
the plurality of wires in the stacked part are arranged such that the stacked part is greater in thickness than the flat parts in the thickness direction of the flat parts, and is narrower in width than the flat parts in a width direction of the flat parts.

16. The wire harness according to claim 1,
wherein the flat part has a flat bent portion in which the plurality of wires bend as seen in the thickness direction of the flat part,
the plurality of wires in the flat bent portion are lined up in a row in a width direction of the flat part, and bend while maintaining the arrangement of being lined up in a row as seen in the thickness direction of the flat part, and
the first tape member and the second tape member sandwich the flat bent portion from both sides in the thickness direction of the flat part, and maintain the arrangement and bent shape of the plurality of wires in the flat bent portion.

17. The wire harness according to claim 1,
wherein the wire bundle has a single-layer bent part in which the plurality of wires bend while lined up flat at a position shifted from the flat part in the direction in which the wire bundle extends,
the plurality of wires in the single-layer bent part are lined up in a row in a direction orthogonal to a thickness direction of the single-layer bent part, and bend while maintaining the arrangement of being lined up in a row, as seen in the thickness direction of the single-layer bend portion,
the wire harness further comprises a third tape member and a fourth tape member affixed together with the single-layer bent part sandwiched therebetween from both sides in the thickness direction of the single-layer bent part, and
the third tape member and the fourth tape member maintain the arrangement and bent shape of the plurality of wires in the single-layer bent part.

18. The wire harness according to claim 1,
wherein the wire bundle has a stacked bent part in which the wire bundle bends at a position shifted from the flat part in the direction in which the wire bundle extends,
the plurality of wires in the stacked bent part bend in a state where the stacked bent part is greater in thickness than the flat part in the thickness direction of the flat part, and is narrower in width than the flat part in a width direction of the flat part,
the wire harness further comprises a first bend fixing tape member and a second bend fixing tape member affixed together with the stacked bent part sandwiched therebetween, and
the first bend fixing tape member and the second bend fixing tape member maintain the arrangement and bent shape of the plurality of wires in the stacked bent part.

19. The wire harness according to claim 1,
wherein the flat part is maintained in a straight state by the first tape member and the second tape member, as seen in a width direction of the flat part.

20. The wire harness according to claim 1,
wherein the flat part is maintained in a curved shape by the first tape member and the second tape member, as seen in a width direction of the flat part.
